(19) United States
(12) Patent Application Publication
(10) Pub. No.: US 2023/0266762 A1
(43) Pub. Date: Aug. 24, 2023

(54) Autonomous Movement Device, Autonomous Movement Method, And Program

(71) Applicant: Doog Inc., Ibaraki (JP)

(72) Inventors: Akira Oshima, Ibaraki (JP); Hiroyasu Kuniyoshi, Ibaraki (JP); Shigeru Bando, Ibaraki (JP); Saku Egawa, Ibaraki (JP)

(21) Appl. No.: 18/002,029

(22) PCT Filed: Apr. 9, 2021
(86) PCT No.: PCT/JP2021/015009

§ 371 Date: Dec. 15, 2022

(30) Foreign Application Priority Data
Jun. 15, 2020 (WO) PCTJP2020023468

(51) Int. Cl. G05D 1/02

(52) U.S. Cl. CPC G05D 1/0212

(57) ABSTRACT

An autonomous movement device includes driven wheels, a storage, and a processor. The processor: causes taught memorized data to be memorized in the storage; based on the memorized data, controls the driven wheels to cause the autonomous movement device to autonomously travel; at a hold point, the hold point being a point at which autonomous travel of the autonomous movement device is suspended, controls the driven wheels to cause the autonomous movement device to travel in a travel mode other than the autonomous travel; and, when the autonomous movement device reaches near the hold point in a travel mode other than the autonomous travel, causes the suspended autonomous travel to be resumed.

### FIELD OF THE INVENTION

The present disclosure relates to an autonomous movement device, an autonomous movement method, and a program.

### BACKGROUND OF THE INVENTION

Conventionally, mobile robots have been used for article transportation in factories, guidance of persons in facilities, and the like. As a method for setting a travel path for such a mobile robot, a method in which a person teaches a travel path to the mobile robot has been used. For example, Patent Literature 1 discloses an autonomously traveling work device that executes teaching travel in a manual travel mode and, in an autonomous travel mode, is capable of autonomously traveling along a taught travel path, based on travel data memorized in the teaching travel.

### Citation List

### Patent Literature

Patent Literature 1: Unexamined Japanese Patent Application Publication No. 2018-112917

### SUMMARY OF THE INVENTION

### Technical Problem

Although the autonomously traveling work device disclosed in Patent Literature 1 is capable of autonomously traveling along a travel path in the autonomous travel mode, the autonomously traveling work device is incapable of traveling along a route other than the taught travel path. Thus, when, for example, a situation in which the autonomously traveling work device is expected to temporarily travel to another place while traveling along the travel path (for example, the autonomously traveling work device is expected to clean a space slightly away from the route, is expected to pick up a load at a place slightly away from the route, or the like) occurs, a user or the like is required to correct memorized data, perform the teaching travel again, or manually cause the autonomously traveling work device to travel from the start point to the end point of the route without using the autonomous travel mode.

The present disclosure has been made in consideration of the above-described situation, and an objective of the present disclosure is to provide an autonomous movement device and the like that, even while autonomously traveling along a taught travel path, can be caused to temporarily travel in a travel mode other than autonomous travel during travel along the travel path.

### Solution to Problem

In order to achieve the above-described objective, an autonomous movement device according to a first aspect of the present disclosure is an autonomous movement device including:
movement means;
storage means; and
control means,
in which the control means
causes taught memorized data to be memorized in the storage means,
based on the memorized data, controls the movement means to cause the autonomous movement device to autonomously travel,
at a hold point, the hold point being a point at which autonomous travel of the autonomous movement device is suspended, controls the movement means to cause the autonomous movement device to travel in a travel mode other than the autonomous travel, and
when the autonomous movement device reaches near the hold point in a travel mode other than the autonomous travel, causes the suspended autonomous travel to be resumed.

The control means may,
at the hold point at which autonomous travel of the autonomous movement device is suspended, memorize a travel direction of the autonomous movement device in the storage means as a hold direction,
when the autonomous movement device reaches near the hold point in a travel mode other than the autonomous travel, determine whether or not a travel direction of the autonomous movement device coincides with the hold direction, and
when the travel direction does not coincide with the hold direction, after controlling the movement means to cause the autonomous movement device to turn in such a way that the travel direction coincides with the hold direction, cause the suspended autonomous travel to be resumed.

The control means may,
at the hold point at which autonomous travel of the autonomous movement device is suspended, memorize a travel direction of the autonomous movement device in the storage means as a hold direction,
when the autonomous movement device reaches near the hold point in a travel mode other than the autonomous travel, determine whether or not a travel direction of the autonomous movement device is an opposite direction to the hold direction, and
when the travel direction is an opposite direction to the hold direction, cause the autonomous travel to be resumed in such a way that the autonomous movement device travels to a start point at which the autonomous movement device started the autonomous travel, along a route obtained by reversing a direction of a route from the start point to the hold point.

The autonomous movement device further includes operation acquisition means for acquiring a user operation,
in which the control means may,
when the control means acquires a user operation by the operation acquisition means during the autonomous travel, suspend autonomous travel and memorize a location of the autonomous movement device and a travel direction of the autonomous movement device at a moment of the suspension as a hold point and a hold direction, respectively, in the storage means.

The autonomous movement device further includes operation acquisition means for acquiring a user operation,
in which the control means may,
even when the control means acquires a same operation by the operation acquisition means, perform different control depending on a state of the autonomous movement device at a moment of the acquisition on the autonomous movement device.

The autonomous movement device further includes output means,
in which the control means may,
while the control means suspends the autonomous travel, cause the output means to output a signal indicating that autonomous travel is resumable.

The autonomous movement device further includes detection means for detecting a surrounding object,
in which the control means may
   recognize a following target from among objects detected by the detection means, and
   at a time of generating route data of a surrounding environment, based on data of a point cloud detected by the detection means, generate the route data without using the data of the following target but using the data of an object other than the following target.

The autonomous movement device further includes output means,
in which the control means may,
when storage of the memorized data is finished, cause the output means to output a signal indicating that memorizing processing is finished.

The control means may, at a time of causing the autonomous movement device to autonomously travel based on the memorized data, adjust a travel path.

In addition, an autonomous movement method according to a second aspect of the present disclosure is an autonomous movement method for an autonomous movement device including:
storing taught memorized data in storage means;
based on the memorized data, controlling movement means to cause the autonomous movement device to autonomously travel,
at a hold point, the hold point being a point at which autonomous travel of the autonomous movement device is suspended, controlling the movement means to cause the autonomous movement device to travel in a travel mode other than the autonomous travel, and
when the autonomous movement device reaches near the hold point in a travel mode other than the autonomous travel, causing the suspended autonomous travel to be resumed.

In addition, a program according to a third aspect of the present disclosure causes a computer of an autonomous movement device to execute:
causing taught memorized data to be stored in storage means,
based on the memorized data, controlling movement means to cause the autonomous movement device to autonomously travel,
at a hold point, the hold point being a point at which autonomous travel of the autonomous movement device is suspended, controlling the movement means to cause the autonomous movement device to travel in a travel mode other than the autonomous travel, and
when the autonomous movement device reaches near the hold point in a travel mode other than the autonomous travel, causing the suspended autonomous travel to be resumed.

### Advantageous Effects of Invention

According to the present disclosure, it is possible to cause an autonomous movement device to, even while autonomously traveling along a taught travel path, temporarily travel in a travel mode other than autonomous travel during travel along the travel path.

### BRIEF DESCRIPTION OF THE DRAWINGS

FIG. 1 is a block diagram illustrating a functional configuration of an autonomous movement device according to Embodiment 1 of the present disclosure;

FIG. 2 is a diagram illustrating an external appearance of the autonomous movement device according to Embodiment 1;

FIG. 3 is a diagram illustrating an external appearance of a sensor that the autonomous movement device according to Embodiment 1 includes and a laser radiated from the sensor;

FIG. 4 is a diagram of the sensor and an operation acquirer that the autonomous movement device according to Embodiment 1 includes as viewed from a side face of the autonomous movement device;

FIG. 5 is a diagram illustrating a surrounding environment detected by the sensor according to Embodiment 1;

FIG. 6 is a diagram illustrating an example of the operation acquirer according to Embodiment 1;

FIG. 7A is an explanatory diagram of a surrounding environment in the forward direction;

FIG. 7B is an explanatory diagram of a surrounding environment in the backward direction;

FIG. 8 is a diagram illustrating an example of travel modes of the autonomous movement device according to Embodiment 1;

FIG. 9 is a flowchart of memorizing processing performed by the autonomous movement device according to Embodiment 1;

FIG. 10 is a diagram illustrating a case where the autonomous movement device according to Embodiment 1 is taught a route from a first point to a second point and a route from a third point to a fourth point;

FIG. 11 is a first part of a flowchart of playback processing performed by the autonomous movement device according to Embodiment 1;

FIG. 12 is a second part of the flowchart of the playback processing performed by the autonomous movement device according to Embodiment 1;

FIG. 13 is a third part of the flowchart of the playback processing performed by the autonomous movement device according to Embodiment 1;

FIG. 14 is a diagram illustrating route adjustment in the playback processing performed by the autonomous movement device according to Embodiment 1; and

FIG. 15 is a diagram illustrating an external appearance of an autonomous movement device according to a variation.

### DETAILED DESCRIPTION OF THE INVENTION

An autonomous movement device according to an embodiment of the present disclosure is described below with reference to the drawings. Note that, in the drawings, the same or equivalent constituent elements are designated by the same reference numerals.

### Embodiment 1

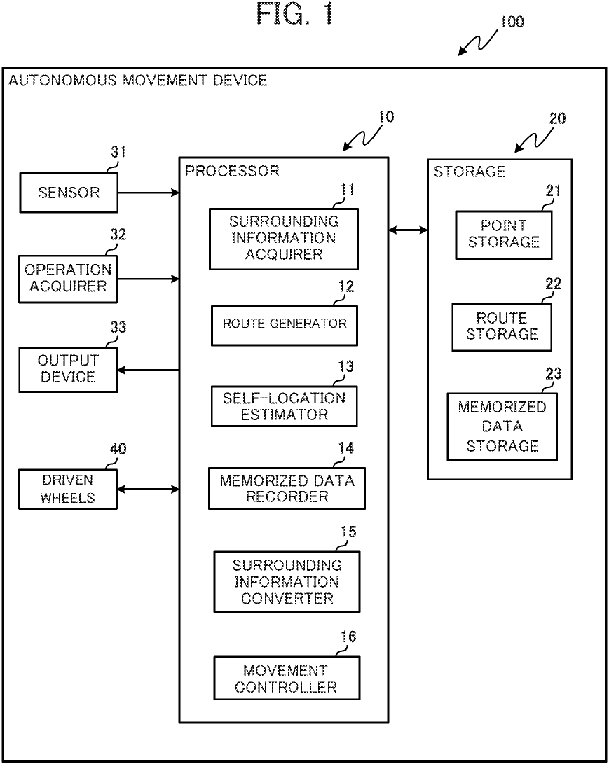

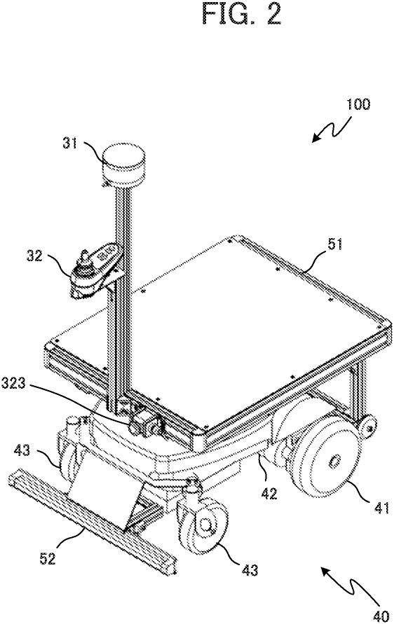

The autonomous movement device according to the embodiment of the present disclosure is a device that, by being taught a travel path by a user, storing memorized data, and reproducing the stored memorized data, autonomously moves based on the taught travel path (teaching route) from a start point to a goal point of the teaching route. Travel based on playback of memorized data is referred to as autonomous travel, and travel other than the autonomous travel (line trace, manual operation travel, autonomous target following travel, hand-pushing travel, remote operation travel, travel based on an instruction from another system, or the like) is collectively referred to as guided travel. An example of a functional configuration and an example of an external appearance of an autonomous movement device 100 according to Embodiment 1 are illustrated in FIGS. 1 and 2, respectively.

As illustrated in FIG. 1, the autonomous movement device 100 includes a processor 10, a storage 20, a sensor 31, an operation acquirer 32, an output device 33, and driven wheels 40.

The processor 10 includes a central processing unit (CPU) and the like and achieves functions of respective units (a surrounding information acquirer 11, a route generator 12, a self-location estimator 13, a memorized data recorder 14, a surrounding information converter 15, and a movement controller 16), which are described later, by executing programs stored in the storage 20. The processor 10 also includes a clock (not illustrated) and is capable of acquiring a current date and time and counting elapsed time. The processor 10 functions as control means.

The storage 20 includes a read only memory (ROM), a random access memory (RAM), and the like, and a portion or all of the ROM is constituted by an electrically rewritable memory (a flash memory or the like). In the ROM, programs that the CPU of the processor 10 executes and data that are required in advance for the CPU to execute the programs are stored. In the RAM, data that are generated or changed during execution of programs are stored. The storage 20 functions as storage means. The storage 20 also includes a point storage 21, a route storage 22, and a memorized data storage 23, which are described later, as functional constituent elements.

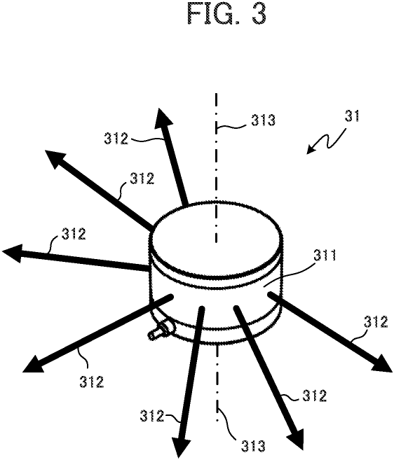

The sensor 31 includes a scanner-type LiDER (Light Detection and Ranging) and the like serving as sensing devices and detects objects, such as a person, a wall, an obstacle, and a reflective material, that exist in the surroundings around the autonomous movement device 100 (in the present embodiment, in the right, left, and front directions of the autonomous movement device 100) as a group of points (point cloud). The sensor 31 radiates a laser 312 from a light emitter that is disposed inside an optical window 311, as illustrated in FIG. 3 and captures a laser reflected by an object, such as a person, a wall, an obstacle, and a reflective material, by a light receiver that is disposed inside the optical window 311. In addition, the light emitter (and the light receiver) radiates the laser 312 while changing a scan angle by rotating 320 degrees (plus and minus 160 degrees when the straight forward direction of the autonomous movement device 100 is assumed to be 0 degrees) about a rotational axis 313 and thereby scans the surroundings. By processing a signal from the light receiver that captures a reflected laser, the sensor 31 is capable of, with respect to each scan angle, measuring distance to an object existing in the direction of the angle and received light intensity. Note that the above-described setting in which the range of rotation angle (scan angle) of the light emitter is set to “plus and minus 160 degrees when the straight forward direction of the autonomous movement device 100 is assumed to be 0 degrees” is only an example and a specification may stipulate that the light emitter rotates plus and minus 180 degrees or rotates plus and minus 100 degrees. In addition, the scan angle does not have to be bilaterally symmetric.

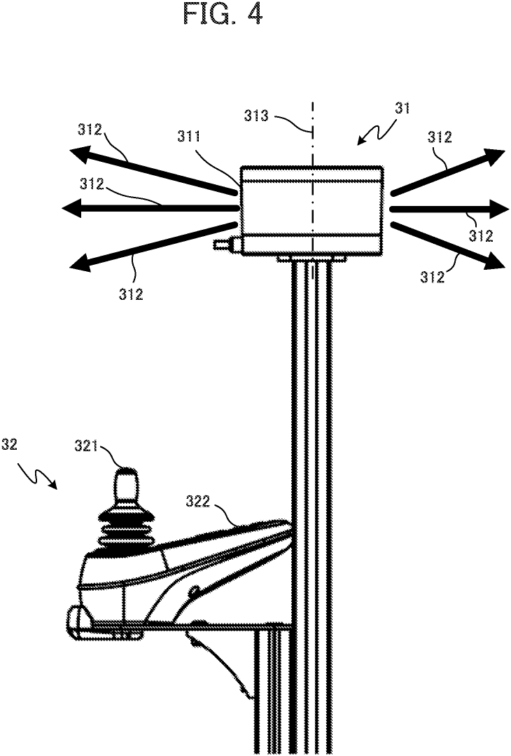

The sensor 31 has the rotational axis 313 of scan extending in the vertical direction, as illustrated in FIG. 4, and the laser 312 is configured to three-dimensionally scan an object (such as a person, a wall, an obstacle, and a reflective material) existing in the right and left directions and the forward direction of the autonomous movement device 100. The sensor 31 is capable of detecting an object when the sensor 31 can receive a laser reflected by the object by the light receiver, and is capable of detecting even an object existing at a position located, for example, 200 m away from the sensor 31. In addition, the three-dimensional scan performed by the sensor 31 enables a three-dimensional shape of an object to be detected. The sensor 31 functions as detection means. Note that the constituent element of the sensor 31 is not limited to a scanner-type LiDER(Light Detection and Ranging) and the sensor 31 may be constituted by a camera or another device capable of measuring distance and received light intensity.

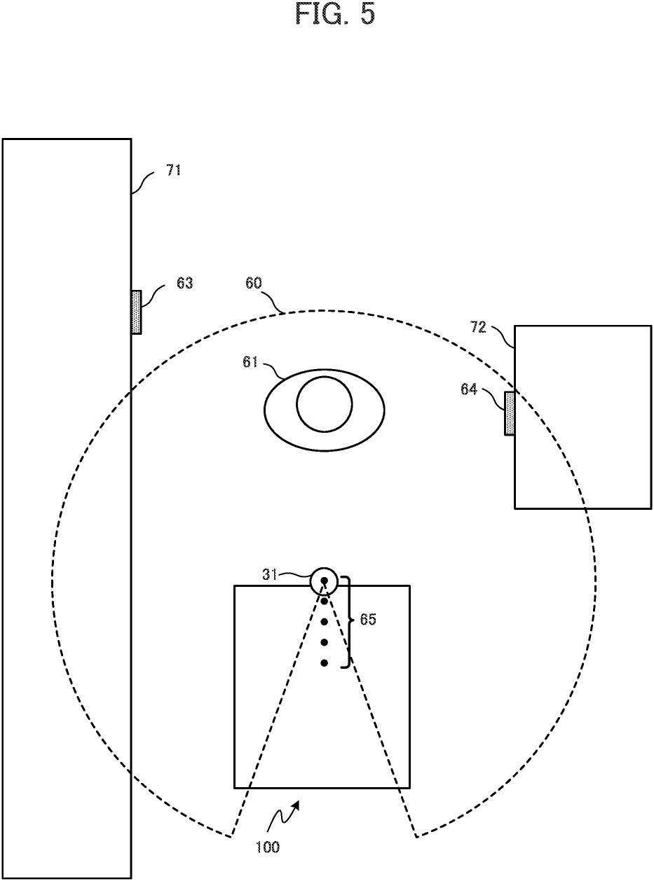

The sensor 31, for example, detects how far each of locations at which a wall 71 and a reflective material 63, a person 61, and an obstacle 72 and a reflective material 64 exist on the left side, in front, and on the right side of the autonomous movement device 100, respectively, is from the autonomous movement device 100, as illustrated in FIG. 5. Note that a dotted line 60 indicates an angle of a radiation range (320 degrees) of the laser radiated from the sensor 31 and does not indicate radiation distance. The laser is radiated to a range beyond the dotted line 60 in terms of distance, and, for example, the reflective material 63 is also detected. Note, however, that the laser is not radiated to an angular range of 40 degrees behind the autonomous movement device 100, as illustrated by the dotted line 60. Since the sensor 31 is capable of acquiring distances and angles to points at which lasers are reflected, the processor 10 is capable of acquiring, based on the distances and angles, data of a group of coordinates (X, Y) of the points (point cloud) where, for example, distance in the straight forward direction from the autonomous movement device 100 to each of the points is denoted by X and displacement in the lateral direction of the point from the autonomous movement device 100 is denoted by Y.

In addition, the processor 10 may recognize an object that the sensor 31 detected, based on information (distance to the object, received light intensity, and the like) that the processor 10 acquired from the sensor 31. For example, the processor 10 may recognize that an object is a reflective material (a so-called retro reflective material when a condition for recognizing the object as a reflective material, such as a condition requiring received light intensity to be more intense than a predetermined standard intensity, is satisfied. In addition, the processor 10 may recognize that an object is a person when a condition for recognizing the object as a person, such as a condition requiring width of the object to be approximately a width of a person (for example, 30 cm to 1 m), is satisfied. Further, the processor 10 may recognize that an object is a wall when a condition for recognizing the object as a wall, such as a condition requiring width of the object to be longer than a predetermined standard value, is satisfied. Furthermore, the processor 10 may recognize that an object is an obstacle when any conditions for recognizing the object as a reflective material, a person, and a wall are not satisfied.

In addition, the processor 10 may, without performing recognition of the type or the like of an object, recognize that some object exists at the location, based on information acquired from the sensor 31. The processor 10, by performing initial detection based on information acquired from the sensor 31 and tracking detected objects (performing scanning at a short interval (for example, 50 milliseconds) and thereby tracking point clouds having small coordinate changes), is capable of detecting more various objects in a stable manner (for example, it is possible to follow not only a person but also another autonomous movement device 100 in a target following mode, which is described later). Note that the recognition method of an object described above is only an example and another recognition method may be used.

A reflective material that is one of objects that the sensor 31 detects is made of a retro reflective material and, when being irradiated with laser light, reflects the laser light in a direction in which the laser light is incident. Therefore, when received light intensity that the sensor 31 detected is higher than the predetermined standard intensity, the processor 10 can recognize that a reflective material exists in a direction at a scan angle at the time in the scan by the sensor 31. For example, at a place with few features, such as a long corridor, little change occurs in information detected by the sensor 31 even when the autonomous movement device 100 moves along the corridor in the longitudinal direction, and it becomes difficult for the processor 10 to recognize how far the autonomous movement device 100 has moved in the longitudinal direction. Even in such a case, installing the retro reflective materials 63 on the wall 71 enables the processor 10 to recognize how far the autonomous movement device 100 has moved along the passageway in the longitudinal direction, based on the number of and an arrangement of detected retro reflective materials, which enables construction of a more accurate map and stable travel.

Note that the retro reflective materials 63 are installed at locations that are irradiated with laser light radiated from the sensor 31 (in the present embodiment, locations having approximately the same height as the height of the sensor 31). In addition, the reflective material can be installed by applying paint including a retro reflective material to a wall or the like, sticking a pressure sensitive adhesive tape including a retro reflective material on a wall or the like, or suspending a rope or the like including a retro reflective material (which may be produced by applying paint including a retro reflective material to a general rope or the like or winding a pressure sensitive adhesive tape including a retro reflective material around a general rope or the like) in the air. In addition, even when a retro reflective material is not used, by detecting brightness of a target object by use of reflection intensity of a laser and storing the detected brightness in the route storage 22, which is described later, the brightness data can be used for matching with the route data as a feature. For example, even at a long corridor that has a small feature value in terms of shape, a bright color or a dark color can be detected to some extent by reflection intensity of a laser. Thus, by recognizing change in the level of the reflection intensity as a brightness pattern and using the brightness pattern for matching with the route data, autonomous travel that does not require a special preparation in the surrounding environment can be achieved.

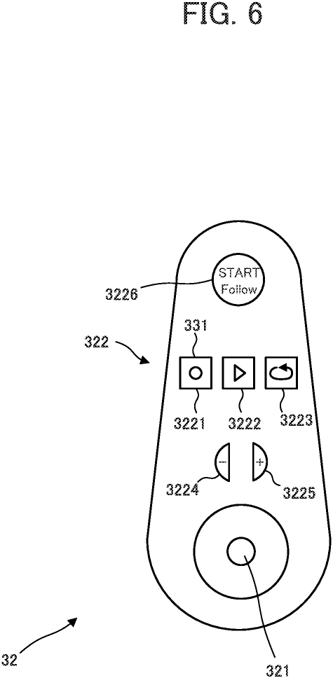

Returning to FIG. 1, the operation acquirer 32 includes an input device, such as a joystick, and acquires a user operation. The operation acquirer 32 functions as operation acquisition means. As illustrated in FIG. 4, the operation acquirer 32 includes a joystick 321 and a push buttons 322. The user can instruct the autonomous movement device 100 on a travel direction and movement velocity by a direction in which the user tilts the joystick 321 and a tilt amount (tilt angle), respectively. In addition, as the push buttons 322, a storage button 3221 for instructions to start and end teaching, a playback button 3222 for instructions to start and end playback, a loop playback button 3223 for an instruction to start loop playback, a deceleration button 3224 for instructions to perform reverse playback and to decelerate, an speed increase button 3225 for instructions to perform playback correction and to accelerate, a start button 3226 for an instruction to switch a travel mode among a manual operation mode, an autonomous target following mode, and a line trace mode, and the like are provided, as illustrated in FIG. 6. The push buttons 322 as described above have high visibility in an outdoor work site or the like and improve convenience. Note that the reverse playback is playback processing that, by reproducing memorized data in the backward direction, causes the autonomous movement device 100 to move in such a manner as to return from a goal point to a start point. In addition, the playback correction is playback processing that, during playback of memorized data, also performs correction of the route data. Further, the loop playback is playback processing that can be performed when the goal point of a teaching route coincides with the start point of the teaching route or is a point near the start point and, by reproducing memorized data repeatedly, causes the autonomous movement device 100 to perform travel from the start point to the goal point of the teaching route repeatedly.

Note that the operation acquirer 32 may include, in place of the push buttons or in addition to the push buttons, a touch panel that displays a user interface (UI) to accept a user instruction. In this case, on a display of the touch panel, an operation menu (a menu for performing setting of a maximum velocity, a maximum acceleration, and the like and selection of a setting value for each thereof, specification of a destination, movement stop instruction, instruction of start and end of teaching, playback, reverse playback, loop playback, or the like, selection of a travel mode (a playback mode, a manual operation mode, or the like), and the like) is displayed, and the user can provide the autonomous movement device 100 with each instruction by touching one of the instructions in the operation menu.

The output device 33 includes a speaker and light emitting diodes (LEDs) and outputs a signal notifying the user of a state and the like of the autonomous movement device 100. In the present embodiment, the LEDs are incorporated in the push buttons 322 of the operation acquirer 32, and, as illustrated in FIG. 6, an LED 331 is incorporated in the storage button 3221. For example, during memorizing processing, which is described later, the LED 331 is turned on, and, when the teaching is ended and a route is memorized, the LED 331 is turned off. In addition, although not illustrated, an LED displaying remaining battery power or an LED displaying traveling speed may be included. The output device 33 functions as output means and is capable of notifying the user of a current state and the like of the autonomous movement device 100 by a lighting condition of the LEDs or a sound output from the speaker.

In addition, although not illustrated, the autonomous movement device 100 may include a communicator that communicates with an external system (a personal computer (PC), a smartphone, or the like). The autonomous movement device 100 may, using the communicator, send a current state or various types of data (for example, route data and memorized data) to the external system or receive various types of data (for example, modified route data and memorized data) from the external system.

In addition, types of teaching include not only target following teaching in which teaching is performed by causing the autonomous movement device 100 to follow a following target but also manual teaching in which teaching is performed by manually operating the autonomous movement device 100 using the joystick 321 or the like of the operation acquirer 32. The user can also switch which one of the target following teaching and the manual teaching is to be performed, using the start button 3226 of the operation acquirer 32. Although, in the present embodiment, memorizing processing that is arbitrarily switchable between the target following teaching and the manual teaching is described, only difference between the target following teaching and the manual teaching is whether memorized data are acquired by following a following target or acquired through the operation acquirer 32, and the present disclosure is applicable to not only these teaching methods but also teaching through other arbitrary motion (teaching through hand-pushing travel, teaching based on input from an external system, or the like).

Returning to FIG. 1, the driven wheels 40 cause the autonomous movement device 100 to move, based on instructions (control) from the processor 10. The driven wheels 40 function as movement means. As illustrated in FIG. 2, the driven wheels 40 include wheels 41 of an independent two-wheel drive type, motors 42, and casters 43. The autonomous movement device 100 is capable of performing parallel movement (translational movement) in the longitudinal direction by driving the two wheels 41 in the same direction, rotation (direction change) on the spot by driving the two wheels 41 in the opposite directions, and turning movement (translational movement and rotation (direction change) movement) by individually driving the two wheels 41 at different velocities. In addition, a rotary encoder is attached to each of the wheels 41, and the processor 10 is capable of calculating the amount of translational movement and the amount of rotation by use of the numbers of rotations of the wheels 41 measured by the rotary encoders, diameter of the wheels 41, distance between the wheels 41, and the like.

For example, when diameter and the number of rotations of each of the wheels 41 are denoted by D and C, respectively, the amount of translational movement covered by ground contact points of the wheel 41 is calculated by π·D·C. In addition, when the diameter of each of the wheels 41 is denoted by D, the distance between the wheels 41 is denoted by I, the number of rotations of the right wheel 41 is denoted by CR, and the number of rotations of the left wheel 41 is denoted by CL, the amount of rotation in the direction change is calculated by 360° × D × (CL - CR)/(2 × I) (when the clockwise rotation is defined to be positive). The driven wheels 40 also function as mechanical odometry by respectively adding the amounts of translational movement and the amounts of rotation successively, which enables the processor 10 to grasp the location (a location and direction based on a location and direction at the time of movement start) of the autonomous movement device 100.

Note that the autonomous movement device 100 may be configured to include crawlers instead of the wheels 41 or may be configured to include a plurality of (for example, two) legs and perform movement by walking using the legs. In these cases, as with the case of the wheels 41, it is also possible to measure a location and direction of the autonomous movement device 100, based on motion of the two crawlers, motion of the legs, or the like.

In addition, as illustrated in FIG. 2, the autonomous movement device 100 includes a loading platform 51 and is capable of mounting a transportation article and the like on the loading platform 51 and transporting the transportation article and the like to a destination. The autonomous movement device 100 is also capable of towing a wheeled platform or the like by attaching a towing receiving fitting to the edge of a rear central portion of the loading platform 51. Further, the autonomous movement device 100 includes a bumper 52 and is capable of stopping when the autonomous movement device 100 collides with another object and mitigating impact of the collision. Furthermore, the autonomous movement device 100 includes an emergency stop button 323, and the user can manually cause the autonomous movement device 100 to stop in emergency.

Next, a functional configuration of the processor 10 of the autonomous movement device 100 is described. As illustrated in FIG. 1, the processor 10 functions as each of the surrounding information acquirer 11, the route generator 12, the self-location estimator 13, the memorized data recorder 14, the surrounding information converter 15, and the movement controller 16 and performs movement control and the like of the autonomous movement device 100.

The surrounding information acquirer 11 acquires locations of objects that the sensor 31 detected, as point cloud data. In addition, when the start button 3226 is pressed and the autonomous movement device 100 is thereby put into an autonomous target following mode or a target following teaching mode, the surrounding information acquirer 11 recognizes point clouds (a person, another autonomous movement device 100, or the like) existing in front of the autonomous movement device 100 as a following target.

The route generator 12 generates route data of a surrounding environment around the autonomous movement device 100, based on point cloud data detected by the sensor 31. In the present embodiment, point cloud data acquired in one scan by the laser 312 of the sensor 31 serve as a frame of route data. The point cloud data serve as, for example, a surrounding environment indicating an existence situation of objects (a wall, an obstacle, a reflective material, and the like) around the autonomous movement device 100 including locations (distance, direction, and the like) and the like of the objects. Any data format can be employed for the route data. The route generator 12 may generate route data by, for example, simultaneous localization and mapping (SLAM), using data detected by the sensor 31.

In the present embodiment, the route generator 12 constructs the route data by successively recording point cloud data equivalent to one frame of route data (a surrounding environment indicating an existence situation of objects around the autonomous movement device 100) that the autonomous movement device 100 detects by the sensor 31 at a predetermined interval in the route storage 22, which is described later. As a predetermined interval at which the route generator 12 records data equivalent to one frame of route data, every predetermined movement amount (for example, 50 cm), every predetermined period (for example, 0.2 seconds), every rotation of a predetermined angle (for example, 45 degrees), or the like can be set. In the present embodiment, by saving frame-by-frame route data and, at the time of traveling, using the route data by switching frames of route data one after another at each predetermined interval, a so-called cumulative error problem (closed-loop problem) in SLAM is prevented from occurring. Therefore, even for a large-scale route, more robust and reliable map-based autonomous movement can be achieved.

The self-location estimator 13 compares point cloud data detected by the sensor 31 with the route data recorded in the route storage 22 and thereby estimates a self-location of the autonomous movement device 100 in a compared frame. Note that the self-location estimator 13 may acquire information about the present location (self-location) of the autonomous movement device 100, using values of the mechanical odometry obtainable from the driven wheels 40.

The memorized data recorder 14 records memorized data acquired through memorizing processing, which is described later, in the memorized data storage 23. The memorized data includes route data recorded on a frame-by-frame basis at a predetermined interval and a point sequence in which coordinates of locations of the autonomous movement device 100 at which the autonomous movement device 100 actually traveled continue, as data successively recorded during the memorizing processing. For example, as illustrated in FIG. 5, when the autonomous movement device 100 travels straight following the person 61, a point sequence 65 is included in the memorized data. In addition, when the user instructs the autonomous movement device 100 to temporarily stop, to turn on/off the LED 331, and the like, details of the instructions are also successively recorded in the memorized data. The memorized data recorder 14 may record a plurality of pieces of memorized data in the memorized data storage 23 by executing the memorizing processing with respect to a plurality of routes. In addition, although location information and direction information of the start point, location information of the goal point, and location information of a hold point of a teaching route are memorized in the point storage 21, which is described later, these pieces of data may also be included in each piece of memorized data. Note that the start point is a point at which the autonomous movement device 100 is instructed to start the memorizing processing and the goal point is a point at which the autonomous movement device 100 is instructed to end the memorizing processing. In addition, the hold point is a point that is specified, at the time of the memorizing processing, as a point at which the autonomous movement device 100 is to temporarily stop during playback of the memorized data.

When the memorized data is reproduced, the processor 10, after comparing sensor data (point cloud data at that moment in the playback detected by the sensor 31) with the route data recorded in the memorized data storage 23 on a frame-by-frame basis and thereby estimating the location of the autonomous movement device 100 in the frame, controls the driven wheels 40 in such a way that the autonomous movement device 100 travels along a point sequence recorded in the memorized data storage 23 (a point sequence of a route along which the autonomous movement device 100 actually traveled at the time of teaching). When a predetermined condition (for example, a condition requiring traveling 50 cm) is satisfied, the processing moves on to processing of the next frame in the memorized data and the processor 10 performs the same processing using data of the next frame. By repeating the above-described processing, the autonomous movement device 100 performs autonomous travel.

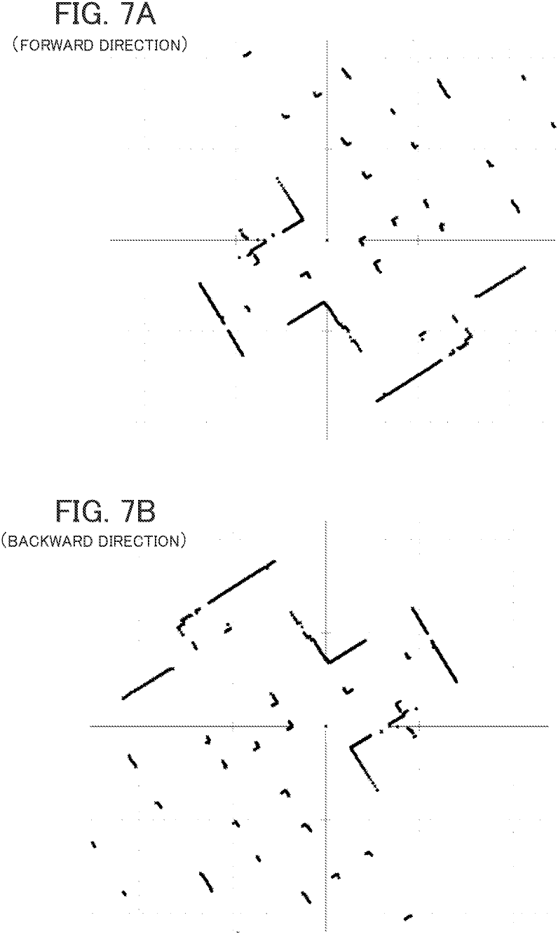

The surrounding information converter 15 converts information about objects in the surroundings around the autonomous movement device 100 (a surrounding environment) recorded in the route storage 22 to data in the backward direction. Data conversion performed by the surrounding information converter 15 is described below using FIGS. 7A and 7B. In the route storage 22, first, a surrounding environment in the forward direction as illustrated in FIG. 7A are recorded. The data in the backward direction is surrounding environment (a surrounding environment illustrated in FIG. 7B) that is to be detected by the sensor 31 when the direction of the autonomous movement device 100 is set to a direction opposite to the direction of the autonomous movement device 100 at the time when the objects in the surroundings were detected by the sensor 31. The data in the backward direction is acquired by, with respect to the original data (the surrounding environment illustrated in FIG. 7A), reversing the forward direction to the backward direction and vice versa and the right direction to the left direction and vice versa (reversing the directions in such a way that an object having been observed ahead is observed behind and an object having been observed on the left side is observed on the right side).

The movement controller 16 controls the driven wheels 40 to cause the autonomous movement device 100 to move. For example, the movement controller 16 controls the driven wheels 40 in such a way that the autonomous movement device 100 moves as instructed or follows a following target during a period from when an instruction to start teaching is input until an instruction to end teaching is input to the operation acquirer 32. In addition, when an instruction to start playback is input to the operation acquirer 32, the movement controller 16 controls the driven wheels 40 in such a way that the autonomous movement device 100 moves in accordance with memorized data memorized in the memorized data storage 23.

Next, a functional configuration of the storage 20 is described. The storage 20 includes the point storage 21, the route storage 22, and the memorized data storage 23.

In the point storage 21, data for determining the location (for example, the location of the start point and the location of the goal point) of the autonomous movement device 100, based on a user operation acquired by the operation acquirer 32 are recorded. For example, when an instruction to start teaching is input to the operation acquirer 32, a surrounding environment that is detected by the sensor 31 at the location and direction of the autonomous movement device 100 at that moment are recorded in the point storage 21 as point data (first point data) at the start point (first point).

In the route storage 22, route data that is generated by the route generator 12 based on a surrounding environment detected by the sensor 31 in the memorizing processing, which is described later, is recorded.

In the memorized data storage 23, a sequence of memorized data acquired by the memorizing processing, which is described later, (route data, a point sequence of locations of the autonomous movement device 100, and data relating to temporary stop and the like taught by the user that are recorded during the teaching) is memorized as memorized data.

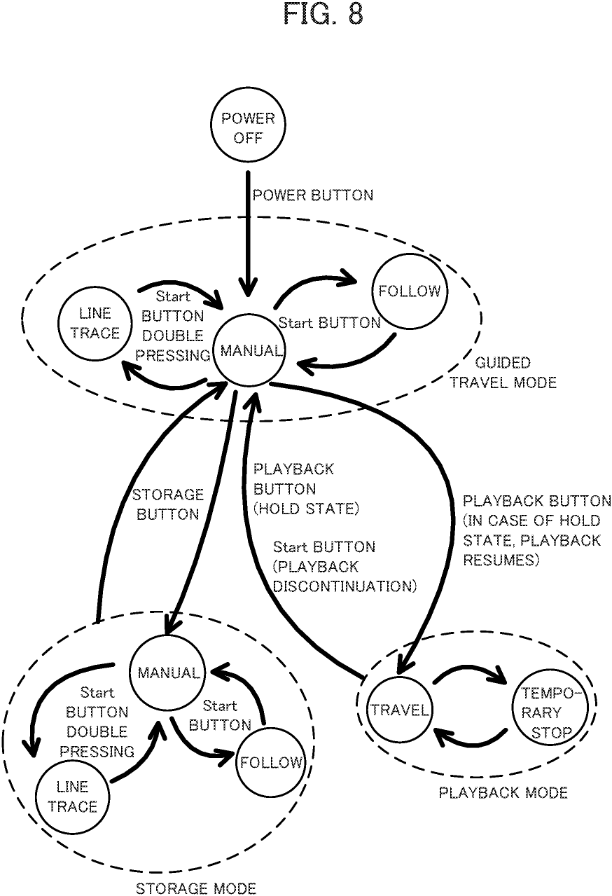

Next, travel modes of the autonomous movement device 100 are described below with reference to FIG. 8. When a power button is pressed while the autonomous movement device 100 is in a power-off state, the autonomous movement device 100 is powered on and put in the manual operation mode. In the manual operation mode, the user can manually operate the autonomous movement device 100 by manipulating the joystick 321 of the operation acquirer 32. When, in the manual operation mode, the user stands in front of the autonomous movement device 100 and presses the start button 3226, the autonomous movement device 100 recognizes the user standing in front thereof as a following target and is switched to the autonomous target following mode. In the autonomous target following mode, when the user walks, the autonomous movement device 100 moves behind the user (autonomously follows the user), and, when the user stops, the autonomous movement device 100 also stops with a certain distance kept to the user. When, in the autonomous target following mode, the user presses the start button 3226 again, the autonomous movement device 100 is switched to the manual operation mode. In addition, when, in the manual operation mode, the user presses the start button 3226 twice, the autonomous movement device 100 is switched to the line trace mode. In the line trace mode, the autonomous movement device 100 travels by tracing a line set with retro reflective materials or the like. When, in the line trace mode, the user presses the start button 3226 twice again, the autonomous movement device 100 is switched to the manual operation mode.

In addition, the autonomous movement device 100 is also capable of performing hand-pushing travel (a movement mode in which the autonomous movement device 100 is caused to travel by the user pushing the autonomous movement device 100 by hand or the like), remote operation travel (a movement mode in which the autonomous movement device 100 travels by acquiring, via the communicator, an operation instruction provided by the user who is present at a place located away from the autonomous movement device 100), and travel based on an instruction from another system (a movement mode in which the autonomous movement device 100 travels based on an instruction from another system received via the communicator). Travel other than the autonomous travel (travel based on the playback of memorized data), such as the manual operation travel, the autonomous target following travel, the line trace, the hand-pushing travel, the remote operation travel, travel based on an instruction from another system, are collectively referred to as guided travel, and a mode in which the autonomous movement device 100 travels in the guided travel is referred to as a guided travel mode.

In addition, when, in the manual operation mode, the user presses the storage button 3221, the LED 331 in the storage button 3221 is turned on and the autonomous movement device 100 is switched to a manual teaching mode. In the manual teaching mode, the user can teach a route by manipulating the joystick 321. When, in the manual teaching mode, the user stands in front of the autonomous movement device 100 and presses the start button 3226, the autonomous movement device 100 recognizes the user standing in front thereof as a following target and is switched to the target following teaching mode. In the target following teaching mode, when the user walks along a route that the user desires to teach, the autonomous movement device 100 moves while following the user, and the route along which the user walked is memorized as a teaching route. When, in the target following teaching mode, the user presses the start button 3226 again, the autonomous movement device 100 is switched to the manual teaching mode.

In addition, when, in the manual teaching mode, the user presses the start button 3226 twice, the autonomous movement device 100 is switched to a line trace teaching mode. In the line trace teaching mode, the autonomous movement device 100 travels in such a manner as to track a line set with retro reflective materials or the like, and memorizes the travel path as memorized data. When, in the line trace teaching mode, the user presses the start button 3226 twice again, the autonomous movement device 100 is switched to the manual teaching mode. In addition, when, in all of the manual teaching mode, the target following teaching mode, and the line trace teaching mode, the user presses the storage button 3221 again, teaching is finished, the LED 331 in the storage button 3221 is turned off, and the autonomous movement device 100 returns to the manual operation mode. The manual teaching mode, the target following teaching mode, and the line trace teaching mode are collectively referred to as a storage mode.

In addition, when, in the manual operation mode, the user presses the playback button 3222, the autonomous movement device 100 is switched to the playback mode. In the playback mode, playback of memorized data is performed, and the autonomous movement device 100 performs autonomous travel (travels or temporarily stops), based on the memorized data. When the user presses the playback button 3222 during playback of the memorized data, the autonomous movement device 100 memorizes a present point as a hold point and is brought into a hold state. In the hold state, the autonomous movement device 100 can temporarily travel in the guided travel mode (the manual operation mode, the autonomous target following mode, the line trace mode, the hand-pushing travel mode, or the like) while keeping retaining information about how far the playback has been performed. When the user causes the autonomous movement device 100 to travel in the hold state until the autonomous movement device 100 returns to the hold location and subsequently presses the playback button 3222, the autonomous movement device 100 returns to the playback mode and the playback is resumed from a point at which the playback was suspended. In addition, when the user reverses the direction of the autonomous movement device 100 at the hold location to the opposite direction and presses the playback button 3222, the autonomous movement device 100 may be configured to reproduce the memorized data in the backward direction and return to the start point. Note that, when the user presses the start button 3226 during playback of the memorized data, the playback is discontinued and the autonomous movement device 100 is switched to the manual operation mode. In the case where the playback is discontinued, when the playback button 3222 is subsequently pressed again, the autonomous movement device 100 reproduces the memorized data from the beginning (from the start point).

In addition, although omitted in FIG. 8, when, in the manual operation mode, the user presses the loop playback button 3223, the autonomous movement device 100 is switched to a loop playback mode. The loop playback mode is a mode in which travel along a teaching route is repeated (a movement similar to a movement at the time when the playback button 3222 is automatically pressed again at the goal point of the teaching route is performed), and the goal point of the teaching route is required to coincide with the start point of the teaching route or to be a point near the start point. In the loop playback mode, as with the playback mode, when the user presses the playback button 3222 during playback of the memorized data, the autonomous movement device 100 memorizes the point at that moment as a hold point and is brought into the hold state. When the user presses the loop playback button 3223 while the autonomous movement device 100 is in the hold state, the autonomous movement device 100 returns to the loop playback mode. Note that, when the user presses the playback button 3222 while the autonomous movement device 100 is in the hold state, the autonomous movement device 100 returns to, instead of the loop playback mode, the playback mode, and the autonomous movement device 100 stops at the goal point of the teaching route.

In addition, although omitted in FIG. 8, when, in the manual operation mode, the user presses the speed decrease button 3224 while pressing the playback button 3222, the autonomous movement device 100 is switched to a reverse playback mode. In the reverse playback mode, the playback is performed in the backward direction from the goal point to the start point of a teaching route. In the reverse playback mode, the surrounding information converter 15 converts information about objects in the surroundings around the autonomous movement device 100 (a surrounding environment) recorded in the route storage 22 to data in the backward direction. Because of this configuration, even when a route from the goal point to the start point has not been taught, reproducing backward memorized data at the time when a route from the start point to the goal point was taught enables the autonomous movement device 100 to reproduce the teaching route in the backward direction.

In addition, although omitted in FIG. 8, when, in the manual operation mode, the user presses the speed increase button 3225 while pressing the playback button 3222, the autonomous movement device 100 is switched to a playback correction mode. In the playback correction mode, playback correction processing, which is described later, is performed, and the autonomous movement device 100 performs playback of memorized data while correcting the route data as needed basis.

Note that the above-described operation method of the push buttons 322 of the operation acquirer 32 in the respective travel modes is an example and the device to be operated at the time of switching the respective travel modes is not limited to the above-described push buttons 322. For example, it may be configured such that the storage button 3221, the playback button 3222, and the loop playback button 3223 are integrated into a single button (referred to as a universal button for convenience), and, in the case where the universal button is pressed when no memorized data are recorded, the autonomous movement device 100 is switched to the teaching mode, and, in the case where the universal button is pressed when memorized data have already been recorded, the autonomous movement device 100 is switched to the playback mode. It may also be configured such that, in the case where the goal point of a teaching route coincides with the start point thereof or is a point near the start point, when the playback button 3222 (or the universal button) is pressed, the autonomous movement device 100 is switched to the loop playback mode.

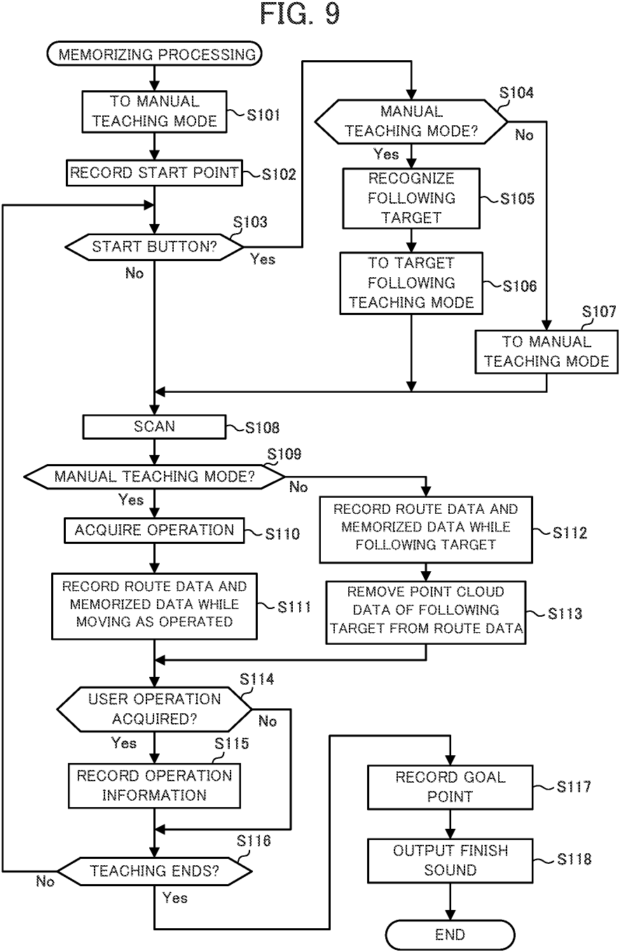

Next, the memorizing processing of the autonomous movement device 100 is described below with reference to FIG. 9. The execution of the memorizing processing is started when the user presses the storage button 3221 of the operation acquirer 32.

First, the processor 10 switches the travel mode of the autonomous movement device 100 to the manual teaching mode (step S101). The processor 10 records a surrounding environment detected by the sensor 31 in the point storage 21 as point data (first point data) at the start point (first point) (step S102). Note that, when the route data have already been recorded in the route storage 22, the processor 10 grasps to what location in the route data the start point corresponds.

Next, the processor 10 determines whether or not the start button 3226 has been pressed (step S103). When the start button 3226 is pressed (step S103; Yes), the processor 10 determines whether or not the travel mode of the autonomous movement device 100 is the manual teaching mode (step S104).

When the travel mode is the manual teaching mode (step S104; Yes), the surrounding information acquirer 11 recognizes the user existing in front of the autonomous movement device 100 as a following target by the sensor 31 (step S105). The processor 10 switches the travel mode of the autonomous movement device 100 to the target following teaching mode (step S106), and the process proceeds to step S108.

When the travel mode is not the manual teaching mode (that is, is the target following teaching mode) (step S104; No), the processor 10 switches the travel mode of the autonomous movement device 100 to the manual teaching mode (step S107), and the process proceeds to step S108.

In contrast, when the start button 3226 has not been pressed (step S103; No), the processor 10 performs scanning using the sensor 31 and acquires information about the surroundings around the autonomous movement device 100 (step S108). The processor 10 determines whether or not the travel mode of the autonomous movement device 100 is the manual teaching mode (step S109).

When the travel mode is the manual teaching mode (step S109; Yes), the processor 10 acquires a user operation (mainly a movement operation using the joystick 321) by the operation acquirer 32 (step S110). While the movement controller 16 controls the driven wheels 40 in accordance with the operation performed by the user, the route generator 12 records route data of a surrounding environment around the autonomous movement device 100 (a point cloud data that the sensor 31 detected in step S108) in the route storage 22 on a frame-by-frame basis and the memorized data recorder 14 records the frame-by-frame route data and a point sequence including coordinates of travel locations of the autonomous movement device 100 in the memorized data storage 23 as memorized data (step S111), and the process proceeds to step S114.

Note that, when retro reflective materials are recognized by the surrounding information acquirer 11, the route generator 12 also records the locations and the number of the retro reflective materials in the route storage 22 by including the locations and the number in the route data in step S111. Therefore, even at a position with few features, such as a long corridor, installing retro reflective materials at some places (sticking the retro reflective materials on a wall or the like) enables information about locations at which the retro reflective materials exist and the number of the retro reflective materials to be recorded in the route storage 22. This configuration enables the processor 10 to match recognized information about retro reflective materials with the recorded information about the locations and the number of the retro reflective materials and thereby grasp the self-location of the autonomous movement device 100 more accurately at the time of playback processing, which is described later.

When the travel mode is not the manual teaching mode (that is, is the target following teaching mode) (step S109; No), while the movement controller 16 controls the driven wheels 40 to cause the autonomous movement device 100 to follow a following target recognized by the surrounding information acquirer 11, the route generator 12 records route data of a surrounding environment around the autonomous movement device 100 (a point cloud data that the sensor 31 detected in step S108) in the route storage 22 on a frame-by-frame basis and the memorized data recorder 14 records the frame-by-frame route data and a point sequence including coordinates of travel locations of the autonomous movement device 100 in the memorized data storage 23 as memorized data (step S112). Note that, as with the above-described processing in step S111, when retro reflective materials are recognized by the surrounding information acquirer 11, the route generator 12 also records the locations and the number of the retro reflective materials in the route storage 22 by including the locations and the number in the route data in step S112.

The processor 10 removes the point cloud data of the following target recognized by the surrounding information acquirer 11 from the route data recorded in the route storage 22 (step S113), and the process proceeds to step S114. Note that the processing in step S113 does not necessarily have to be performed separately from the processing in step S112, and it may be configured such that, when the route generator 12 generates route data in step S112, the route generator 12 generates the route data without using the point cloud data of the following target but using point cloud data of objects other than the following target.

In addition, in step S112, the movement controller 16 controls the driven wheels 40 in such a way that, even when the following target moves backward, the autonomous movement device 100 does not move backward (for example, stops). That is, the movement controller 16 is configured not to instruct the driven wheels 40 to move backward while the autonomous movement device 100 follows the following target. This is because, when a section in which backward movement processing is performed is included in a teaching route that is used as a travel path, there is a possibility that the movement control processing becomes complex at the time of playback processing, which is described later. Therefore, in the case of not only the target following teaching but also the manual teaching, the movement controller 16 may control the driven wheels 40 to prevent the autonomous movement device 100 from moving backward in step S111.

In step S114, the processor 10 determines whether or not a user operation has been acquired by the operation acquirer 32. When a user operation is acquired (step S114; Yes), the memorized data recorder 14 records information about the user operation in the memorized data storage 23 as memorized data (step S115), and the process proceeds to step S116. User operations acquired in step S114 are specifically an instruction to perform “temporary stop” specified by pressing the playback button 3222 once (a period of time until the playback button 3222 is pressed again is recorded in the memorized data storage 23 as “temporary stop time”), an instruction to perform “hold location setting” specified by successively pressing the playback button 3222 twice (the autonomous movement device 100 temporarily stops at the location at the time of playback and, when the user presses the playback button 3222, transitions to the hold state), an instruction to perform “LED on/off switching” specified by pressing the loop playback button 3223 (turning on and off of the LED 331 are switched at the location at the time of playback), and the like.

In contrast, when no user operation has been acquired (step S114; No), the process proceeds to step S116.

In step S116, the processor 10 determines whether or not an instruction to end teaching has been input from the operation acquirer 32 (that is, whether or not the storage button 3221 has been pressed). When no instruction to end teaching has been input (step S116; No), the process returns to step S103. When an instruction to end teaching is input (step S116; Yes), the processor 10 records a surrounding environment detected by the sensor 31 in the point storage 21 as point data (second point data) at the goal point (second point) of the teaching route (step S117).

The processor 10 outputs a sound (sound effects, a melody, or the like) that indicates that recording of the memorized data is finished from the speaker of the output device 33 (step S118), and the memorizing processing is terminated. Note that, as a signal indicating that recording of memorized data is finished, not only the above-described sound but also light can be used. For example, the processor 10 may indicate the user that the autonomous movement device 100 is operating in the teaching mode by turning on the LED 331 during teaching, and, in step S118, turn off the LED 331 in order to indicate that the recording of the memorized data is finished.

The memorizing processing was described above. The memorizing processing causes memorized data (data for controlling the autonomous movement device 100 to travel from the start point to the goal point along the teaching route and control data for controlling the autonomous movement device 100 to temporarily stop on the teaching route or turn on or off the LEDs are included in the memorized data) to be generated. Note that, although, in the above description, the start point and the goal point were described as the first point and the second point, respectively, the description only applies to a case where such points are recorded in the point storage 21 for the first time. For example, in the second memorizing processing after a first point and a second point were recorded in the point storage 21 in the first memorizing processing, a start point at which teaching is started and a goal point at which the teaching is ended are recorded as a third point and a fourth point, respectively, in the point storage 21. As described above, a point at which an instruction to start teaching is input (start point) and a point at which an instruction to end teaching is input (goal point) can be recorded in the point storage 21 in a cumulative manner, and a plurality of teaching routes can be recorded in the memorized data storage 23.

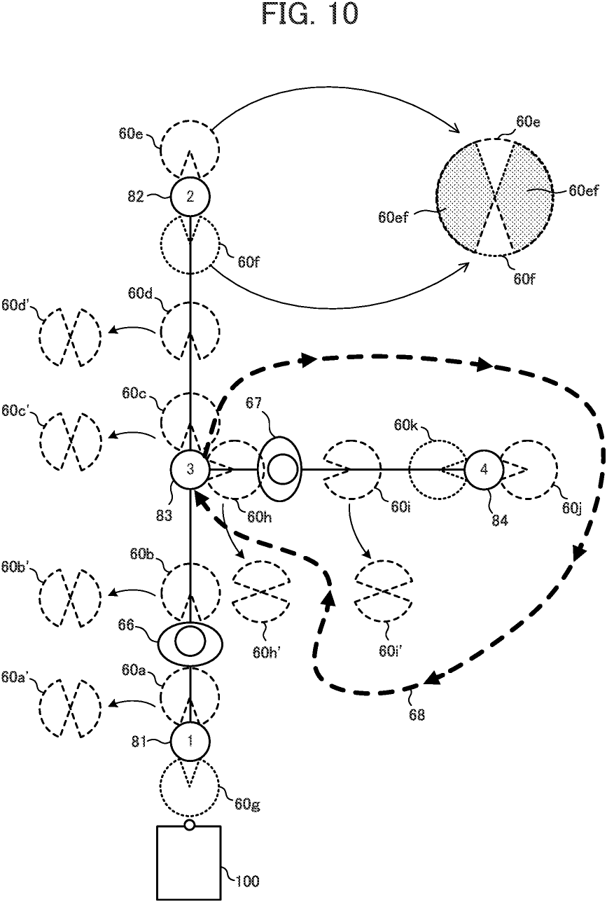

An example of the memorizing processing is described below with reference to FIG. 10. It is assumed that, first, the autonomous movement device 100 receives an instruction to start teaching from a user 66 at a location of a first point 81. Then, the processor 10 records a surrounding environment 60a detected by the sensor 31 in the point storage 21 as point data (first point data) of the start point (step S102). When the user stands in front of the autonomous movement device and presses the start button 3226, the surrounding information acquirer 11 recognizes the user 66 as a following target (step S105).

Although, when the user 66 subsequently walks to a second point 82, the autonomous movement device 100, following the user 66, also moves to the second point 82, the route generator 12 generates route data of a surrounding environment, based on data detected by the sensor 31 (for example, surrounding environments 60b, 60c, and 60d) and records the generated route data in the route storage 22 during movement (step S112). In addition, when the user successively presses the playback button 3222 twice at, for example, a third point 83 during movement to the second point 82 (step S114; Yes), the third point 83 is recognized as a hold point, location information of the third point is recorded in the point storage 21 as location information of the hold point, based on a surrounding environment detected at the third point, and memorized data “temporarily stopping at the third point” are recorded in the memorized data storage 23 (step S115).

When the user 66 inputs an instruction to end teaching in the operation acquirer 32 at the second point 82 (step S116), the processor 10 records a surrounding environment 60e detected by the sensor 31 in the point storage 21 as second point data (step S117). In addition, during the memorizing processing, memorized data for traveling along a route from the first point 81 to the second point 82 (first teaching route) are recorded in the memorized data storage 23.

It is assumed that, subsequently, the autonomous movement device 100, for example, receives an instruction to start teaching from a user 67 while the autonomous movement device 100 faces in a direction toward a fourth point 84 at the location of the third point 83. Then, the processor 10 records a surrounding environment 60h detected by the sensor 31 in the point storage 21 as point data (third point data) of the start point (step S102). When the user stands in front of the autonomous movement device and presses the start button 3226, the surrounding information acquirer 11 recognizes the user 67 as a following target (step S105).

Although, when the user 67 subsequently walks to the fourth point 84, the autonomous movement device 100, following the user 67, also moves to the fourth point 84, the route generator 12 generates route data of a surrounding environment, based on data detected by the sensor 31 (for example, a surrounding environment 60i) and records the generated route data in the route storage 22 during movement (step S112).

When the user 67 inputs an instruction to end teaching in the operation acquirer 32 at the fourth point 84 (step S116), the processor 10 records a surrounding environment 60j detected by the sensor 31 in the point storage 21 as point data (fourth point data) of the goal point (step S117). In addition, during the memorizing processing, memorized data for traveling along a route from the third point 83 to the fourth point 84 (second teaching route) is recorded in the memorized data storage 23.

In this way, point data of respective points, route data, and memorized data are recorded in the point storage 21, the route storage 22, and the memorized data storage 23, respectively, through the memorizing processing. Note that, although, in the above-described memorizing processing (FIG. 9), the description was made assuming that two types of travel modes during memorizing processing, namely the manual teaching mode and the target following teaching mode, are provided, the travel mode during memorizing processing is not limited to the two types of travel modes. The memorizing processing can also be performed by performing the line trace, the hand-pushing travel, the remote operation travel, travel based on an instruction from another system, or the like. In order to achieve memorizing processing based on the above-described travel modes, it is only required to, for example, increase branches based on the types of travel modes in step S109 in FIG. 9 and perform, as processing equivalent to the processing in steps S110 and S111, processing of recording route data and memorized data while causing the autonomous movement device 100 to travel in the respective travel modes, such as the line trace, the hand-pushing travel, and the like.

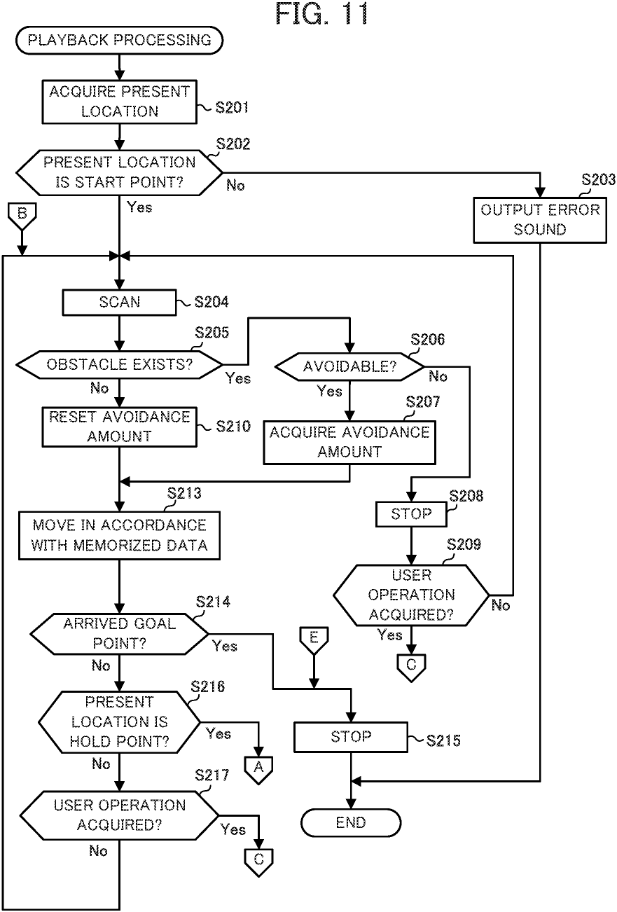

Next, the playback processing of the autonomous movement device 100 is described below with reference to FIGS. 11, 12, and 13. The execution of the playback processing is started when the user presses the playback button 3222 of the operation acquirer 32. Note that, when the user presses the speed decrease button 3224 at the same time as pressing the playback button 3222, reverse playback processing is executed, and, when the user presses the speed increase button 3225 at the same time as pressing the playback button 3222, playback correction processing is executed. Since the reverse playback processing and the playback correction processing are processing that is the same as the playback processing except a small change in a portion of the playback processing, an additional description about the reverse playback processing and the playback correction processing is made as appropriate in the following description of the playback processing.

First, the processor 10 acquires a present location of the autonomous movement device 100 (step S201). In this processing, any acquisition method can be employed for the acquisition of the present location. For example, the processor 10 may acquire the present location of the autonomous movement device 100, using SLAM. The processor 10 may also acquire the present location by comparing data acquired by the sensor 31 with data of the respective points recorded in the point storage 21. A supplementary description on a method for acquiring the present location by comparing data acquired by the sensor 31 with data of the respective points recorded in the point storage 21 is provided below.

Since, in whatever direction the autonomous movement device 100 faces, there occurs some degree of overlap between angular ranges of data acquired by the sensor 31, matching overlapping portions with each other enables whether or not the present location is a point recorded in the point storage 21 to be determined and, when the present location is one of the recorded points, also enables which one of the recorded points the present location is to be determined.

For example, when a case is assumed where the sensor 31 has acquired data in an angular range of 320 degrees and the present location of the autonomous movement device 100 is the second point 82, data detected by the sensor 31 when the autonomous movement device 100 located at the second point 82 faces in a direction opposite to the direction toward the first point 81 is the surrounding environment 60e and data detected by the sensor 31 when the autonomous movement device 100 faces in the direction toward the first point 81 is a surrounding environment 60f, as a result of which there is an overlapping portion having an angular range of 280 degrees (an angular range of 140 degrees on each of the right and left sides) between the surrounding environment 60e and the surrounding environment 60f, as illustrated by shaded portions 60ef, as illustrated in FIG. 10. Therefore, when surrounding environments are compared with each other, the comparison is, for example, performed while one of the surrounding environments is gradually rotated, and, when halves or more (portions equivalent to 280 degrees or more) of the surrounding environments match with each other, the surrounding environments can be estimated to be surrounding environments acquired at an identical point.

In this way, the processor 10 is capable of acquiring which one of the points recorded in the point storage 21 the present location of the autonomous movement device 100 is by comparing a surrounding environment detected by the sensor 31 with data of the respective points recorded in the point storage 21. Note that, when data detected by the sensor 31 do not match with data of any point recorded in the point storage 21, it is impossible to acquire the present location and, in step S201, for example, a value “the present location cannot be acquired” is acquired.

Returning to FIG. 11, the processor 10 determines whether or not the present location acquired in step S201 is the start point recorded in the point storage 21 (step S202). Since, when the present location is not the start point (step S202; No), the determination result means that no teaching route that starts from the location has not been taught, the processor 10 outputs a sound indicating an error from the speaker of the output device 33 (step S203), and the playback processing is terminated.

Note that, when not the playback processing but the reverse playback processing is performed, the determination in step S202 is “whether or not is the present location the goal point?”, and, when the present location is not the goal point, the process proceeds to step S203, and, when the present location is the goal point, the surrounding information converter 15 converts information about objects in the surroundings (a surrounding environment) recorded in the route storage 22 to data in the backward direction, and the process proceeds to step S204.

When the present location is the start point (step S202; Yes), the processor 10 performs scanning using the sensor 31 and acquires information about the surroundings around the autonomous movement device 100 (step S204).

The processor 10 determines whether or not an obstacle exists within a passable width of a passage in the travel direction of the autonomous movement device 100, based on the information about the surroundings acquired in step S204 (step S205). The passable width is a value (in this example, 1.1 m) obtained by adding right and left margins (for example, 5 cm on each of the right and left sides) to the width (for example, 1 m) of the autonomous movement device 100. Not only in the case where an obstacle exists straight in front of the autonomous movement device 100 in the travel direction but also in the case where walls or obstacles on both sides of the travel path in the travel direction intrude into the passable width of the passage, the determination in step S205 results in Yes. This is because, when the autonomous movement device 100 travels straight in this case, there is a possibility that at least one of the right and left sides of the autonomous movement device 100 collides with corresponding one of the walls or obstacles.

When an obstacle exists (step S205; Yes), the processor 10 determines whether or not the autonomous movement device 100 can avoid the obstacle (step S206). In the present embodiment, when the following two conditions are satisfied, the processor 10 determines that the obstacle is avoidable.

The obstacle can be avoided as long as the processor 10 does not lose sight of the present location (self-location) of the autonomous movement device 100 (for example, the processor 10 is able to grasp the self-location by comparing the surrounding environment detected by the sensor 31 with the route data recorded in the route storage 22).

Between the obstacle and another obstacle or a wall, a space having width that allows the autonomous movement device 100 to pass through the space exists.

More specifically, when, based on information about the surroundings acquired in step S204, the amount of lateral movement required to avoid the obstacle is less than or equal to an allowed avoidance width and the width of a space in which no obstacle exists in the travel direction of the autonomous movement device 100 is greater than or equal to the passable width, the determination determines that the obstacle is avoidable, and, otherwise, the determination determines that the obstacle is unavoidable. In this processing, the allowed avoidance width is a maximum value of deviation from a teaching route within a range that allows the autonomous movement device 100 to estimate the self-location based on the route data and the like memorized in the route storage 22 and is, for example, 0.9 m.

Since movement in the lateral direction beyond the allowed avoidance width makes it difficult for the autonomous movement device 100 to estimate the self-location based on information about the surroundings acquired by performing scanning using the sensor 31 and the route data, in the case where the autonomous movement device 100 detects an obstacle in the travel direction, the autonomous movement device 100 avoids the obstacle when the autonomous movement device 100 can avoid the obstacle by deviating from the teaching route within the allowed avoidance width and stops without avoidance when the deviation from the teaching route exceeds the allowed avoidance width. Therefore, even when an obstacle moves to some extent within the allowed avoidance width, the autonomous movement device 100 is capable of traveling while avoiding the obstacle. Conversely, the user can, by, for example, placing an obstacle, such as a cone, right on top of the teaching route, intentionally cause the autonomous movement device 100 to stop before the obstacle.

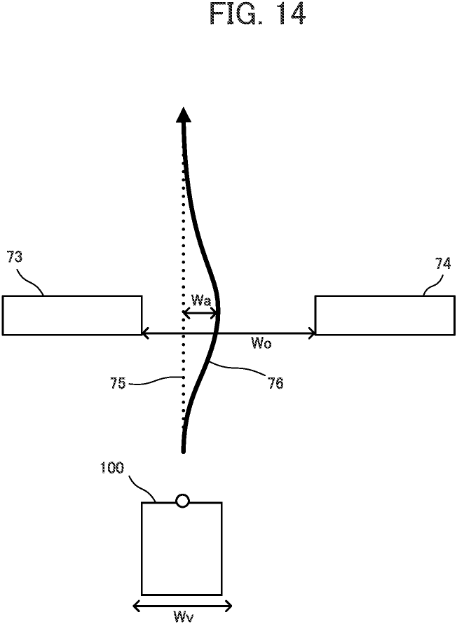

When the autonomous movement device 100 can avoid the obstacle (step S206; Yes), the processor 10 acquires the amount of lateral movement (adjustment width) required to avoid the obstacle as an avoidance amount (step S207), and the process proceeds to step S213. For example, as illustrated in FIG. 14, in the case where an obstacle 73 is close to a point sequence 75 of a teaching route and, when the autonomous movement device 100 travels straight, there is a possibility that the autonomous movement device 100 collides with the obstacle 73, the processor 10 determines, based on information about the surroundings acquired in step S204, that the obstacle 73 is avoidable when width Wo between the obstacle 73 and an obstacle 74 is greater than or equal to passable width Wv and an avoidance amount Wa required to avoid the obstacle 73 is less than or equal to the allowed avoidance width, and acquires Wa as an avoidance amount. In step S213, which is described later, by the processor 10 adjusting a taught travel path indicated by the point sequence 75 by the avoidance amount Wa, the autonomous movement device 100 can travel while avoiding the obstacle 73.

When the autonomous movement device 100 cannot avoid the obstacle (step S206; No), the movement controller 16 controls the driven wheels 40 to cause the autonomous movement device 100 to stop traveling (step S208). In step S208, the processor 10 may notify the user of the fact that the autonomous movement device 100 has stopped traveling by outputting an alarm sound or the like from the speaker of the output device 33. The processor 10 determines whether or not a user operation has been acquired from the operation acquirer 32 (step S209). When no user operation has been acquired (step S209; No), the process proceeds to step S204. This is because there is a possibility that the obstacle has been removed as time passes.

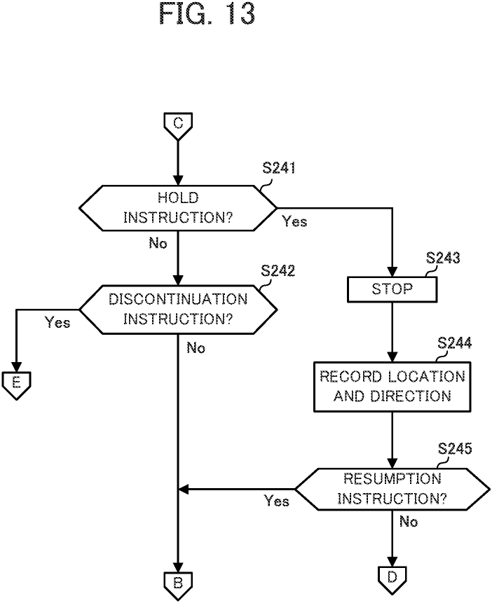

When a user operation is acquired (step S209; Yes), the process proceeds to step S241 in FIG. 13, and the processor 10 determines whether or not the user operation is a hold instruction (the playback button 3222 is pressed, the joystick 321 is manipulated, or the like) (step S241). When the user operation is not a hold instruction (step S241; No), the processor 10 determines whether or not the user operation is a discontinuation instruction (the start button 3226 is pressed) (step S242). When the user instruction is a discontinuation instruction (step S242; Yes), the process proceeds to step S215 in FIG. 11, and the movement controller 16 controls the driven wheels 40 to cause the autonomous movement device 100 to stop traveling (step S215), and the playback processing is terminated. When the user instruction is not a discontinuation instruction (step S242; No), the process proceeds to step S204 in FIG. 11.

In contrast, when the user instruction is a hold instruction (step S241; Yes), in the case where the autonomous movement device 100 is still traveling, the movement controller 16 controls the driven wheels 40 to cause the autonomous movement device 100 to stop traveling (step S243). The processor 10 records the present location and direction of the autonomous movement device 100 in the storage 20 as a hold location and a hold direction, respectively (step S244). The processor 10 determines whether or not a resumption instruction (the playback button 3222 is pressed) has been acquired from the operation acquirer 32 (step S245). When a resumption instruction is acquired (step S245; Yes), the process proceeds to step S204 in FIG. 11.

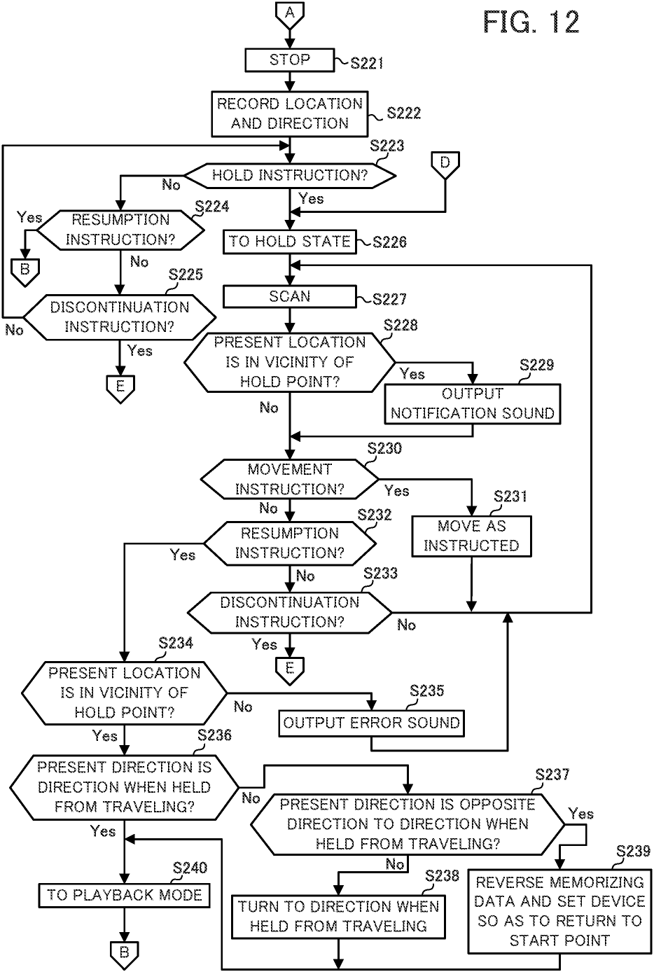

When no resumption instruction has been acquired (step S245; No), the process proceeds to step S226 in FIG. 12. Processing in FIG. 12 enables the autonomous movement device 100 to travel in an arbitrary travel mode other than the autonomous travel from the hold state. Through this processing, the user can, for example, cause the autonomous movement device 100 that is autonomously traveling in the playback processing to temporarily travel to another place and transport a load that the autonomous movement device 100 usually does not transport or to travel along a route along which the autonomous movement device 100 usually does not travel. Details of the processing in FIG. 12 is described later.

On the other hand, when, in step S205 in FIG. 11, no obstacle exists (step S205; No), the processor 10 resets the avoidance amount to avoid an obstacle to 0 (step S210). Through this processing, the subsequent autonomous movement device 100 is controlled in such a manner that the adjustment width of a travel path becomes small and is to return to the original teaching route.

The self-location estimator 13 compares the point cloud data detected by the sensor 31 in step S204 with the route data recorded in the route storage 22 and thereby estimates the self-location and direction of the autonomous movement device 100, and the movement controller 16 controls the driven wheels 40 to cause the autonomous movement device 100 to travel (autonomous travel) in such a way that the self-location estimated by the self-location estimator 13 changes along a point sequence including coordinates of locations of the autonomous movement device 100 at the time of teaching that is recorded in the memorized data storage 23 (step S213). Note, however, that, when an avoidance amount is set in step S207, the processor 10 adjusts the point sequence (travel path) including coordinates of locations of the autonomous movement device 100 at the time of teaching by the avoidance amount, in step S213. Through this processing, as illustrated in FIG. 14, the movement controller 16 controls the driven wheels 40 to cause the autonomous movement device 100 to travel along a route 76 that is obtained by adjusting the point sequence 75 of the original teaching route in such a way that the route avoids the obstacle 73 by the avoidance amount Wa.

Note that, when information about an arrangement and the number of retro reflective materials is recorded in the route data, the processor 10 preferentially matches information about the retro reflective materials (locations and the number of the retro reflective materials) recognized by the surrounding information acquirer 11 with the route data when the processor 10 grasps the present location and direction of the autonomous movement device 100 in step S213. When a state in which the information about retro reflective materials does not match with the route data (for example, the numbers of retro reflective materials differ from each other) persists for a predetermined period (for example, 10 seconds) or for a predetermined movement distance (for example, 10 m), the processor 10 may cause the autonomous movement device 100 to stop. This is because the locations and the number of retro reflective materials can be recognized by the sensor 31 with high precision compared with other general objects and the fact that, despite the advantage, the state in which the information about retro reflective materials does not match with the route data has persisted for a predetermined period or movement distance means that it is highly possible that the autonomous movement device 100 has deviated from the original route.

In the playback processing, as described above, when, while the autonomous movement device 100 is traveling in step S213, a surrounding environment detected by the sensor 31 and the route data recorded in the route storage 22 do not match with each other, the processor 10 determines that it is highly possible that the autonomous movement device 100 has deviated from the original route. In contrast, in the playback correction processing, when a surrounding environment detected by the sensor 31 and the route data recorded in the route storage 22 do not match with each other, the processor 10 considers the surrounding environment detected by the sensor 31 as correct data and performs processing of correcting the route data recorded in the route storage 22 immediately after step S213.

In the playback correction processing, since, when this correction is constantly performed, there is a possibility that travel by the autonomous movement device 100 becomes unstable rather than stable, objects to be used in the correction may be limited to retro reflective materials. That is, it may be configured such that, when a surrounding environment and the route data do not match with each other, information about retro reflective materials included in the surrounding environment is used for correction of the route data and information about objects included in the surrounding environment other than retro reflective materials is used for correction of the present location and direction of the autonomous movement device 100 by comparing the information with the route data.

As described above, in the playback correction processing, it is also possible to correct the route data when a portion of the surrounding environment has changed (for example, a case where, in a distribution warehouse, loads piled up on a pallet that had existed until yesterday have disappeared today). In addition, by adding retro reflective materials to retro reflective materials having already been installed on a wall of a corridor, or the like, it is possible to improve precision of subsequent playback processing.

Returning to the description of FIG. 11, the processor 10 determines whether or not the autonomous movement device 100 has arrived at the goal point by comparing a surrounding environment detected by the sensor 31 with the point data recorded in the point storage 21 (step S214). The determination can be performed through the same processing as that in the above-described determination of the start point in step S202.

When the autonomous movement device 100 arrives at the goal point (step S214; Yes), the movement controller 16 causes the driven wheels 40 to stop (step S215), and the playback processing is terminated.

When the autonomous movement device 100 has not arrived at the goal point (step S214; No), the processor 10 determines whether or not the present location of the autonomous movement device 100 is a hold point by comparing a surrounding environment detected by the sensor 31 with the point data recorded in the point storage 21 (step S216). The determination can also be performed through the same processing as that in the above-described determination of the start point in step S202.

When the present location is not a hold point (step S216; No), the processor 10 determines whether or not a user operation has been acquired from the operation acquirer 32 (step S217). When no user operation has been acquired (step S217; No), the process proceeds to step S204. When a user operation is acquired (step S217; Yes), the process proceeds to step S241 in FIG. 13.

In contrast, when the present location is a hold point in step S216 (step S216; Yes), the process proceeds to step S221 in FIG. 12, and the movement controller 16 causes the driven wheels 40 to stop (step S221). The processor 10 records the present location and direction of the autonomous movement device 100 in the storage 20 as a hold location and a hold direction, respectively (step S222). The processor 10 determines whether or not a hold instruction (the playback button 3222 is pressed) has been acquired from the operation acquirer 32 (step S223).

When no hold instruction has been acquired (step S223; No), the processor 10 determines whether or not a resumption instruction (the playback button 3222 is successively pressed twice) has been acquired from the operation acquirer 32 (step S224). When a resumption instruction is acquired (step S224; Yes), the process proceeds to step S204 in FIG. 11. When no resumption instruction has been acquired (step S224; No), the processor 10 determines whether or not a discontinuation instruction (the start button 3226 is pressed) has been acquired from the operation acquirer 32 (step S225).

When no discontinuation instruction has been acquired (step S225; No), the process returns to step S223. When a discontinuation instruction is acquired (step S225; Yes), the process proceeds to step S215 in FIG. 11.

In contrast, when a hold instruction is acquired in step S223 (step S223; Yes), the processor 10 switches the state of the autonomous movement device 100 to the hold state (step S226). In step S226, the processor 10 may notify the user that the autonomous movement device 100 is currently in the hold state by, for example, turning on the LED 331 of the output device 33.

The processor 10 performs scanning using the sensor 31 and acquires information about the surroundings around the autonomous movement device 100 (step S227). The processor 10 determines whether or not the present location of the autonomous movement device 100 is a location near a hold point (for example, a location having a distance of 10 cm or less from the hold point in any directions) by comparing a surrounding environment detected by the sensor 31 with the information about the hold location recorded in step S222 (step S228).

When the present location is not a location near a hold point (step S228; No), the process proceeds to step S230. When the present location is a location near a hold point (step S228; Yes), the processor 10 outputs a notification sound from the speaker of the output device 33 (step S229) and thereby notifies the user of information “at this location, the autonomous movement device 100 can return from the hold state to the playback mode”.

The processor 10 determines whether or not a movement instruction (for example, a manipulation of the joystick 321) from the user has been acquired from the operation acquirer 32 (step S230). When a movement instruction is acquired (step S230; Yes), the processor 10 controls the driven wheels 40 to cause the autonomous movement device 100 to travel (guided travel) in accordance with the acquired movement instruction (step S231). Note that the travel is not limited to the manual operation travel and may be another arbitrary guided travel (the autonomous target following travel, the hand-pushing travel, the remote operation travel, travel based on an instruction from another system, or the like). The process returns to step S227.

When no movement instruction has been acquired (step S230; No), the processor 10 determines whether or not a resumption instruction (the playback button 3222 is pressed) has been acquired from the operation acquirer 32 (step S232). When no resumption instruction has been acquired (step S232; No), the processor 10 determines whether or not a discontinuation instruction (the start button 3226 is pressed) has been acquired from the operation acquirer 32 (step S233).

When no discontinuation instruction has been acquired (step S233; No), the process returns to step S227. When a discontinuation instruction is acquired (step S233; Yes), the process proceeds to step S215 in FIG. 11.

In contrast, when a resumption instruction is acquired in step S232 (step S232; Yes), the processor 10 determines whether or not the present location of the autonomous movement device 100 is a location near a hold point by comparing the surrounding environment detected in step S227 with the information about the hold location recorded in step S222 or S244 (step S234). Since, when the present location is not a location near a hold location (step S234; No), it is impossible to return to the playback mode at the location, the processor 10 outputs a sound indicating an error from the speaker of the output device 33 (step S235), and the process returns to step S227.

When the present location is a location near a hold location (step S234; Yes), the processor 10 determines whether or not the present direction of the autonomous movement device 100 substantially coincides with the hold direction recorded in step S222 or S244 (for example, having only a difference of 10 degrees or less) (step S236).

When the present direction of the autonomous movement device 100 substantially coincides with the hold direction (step S236; Yes), the autonomous movement device 100 returns from the hold state to the playback mode (step S240), and the process proceeds to step S204 in FIG. 11. When the present direction of the autonomous movement device 100 does not coincide with the hold direction (step S236; No), the processor 10 determines whether or not the present direction of the autonomous movement device 100 substantially coincides with the opposite direction to the hold direction recorded in step S222 or S244 (for example, having only a difference of 10 degrees or less) (step S237).

When the present direction of the autonomous movement device 100 is not the opposite direction to the hold direction (step S237; No), the movement controller 16 controls the driven wheels 40 to cause the autonomous movement device 100 to turn in such a way that the direction of the autonomous movement device 100 coincides with the hold direction (furthermore, in such a way that the location of the autonomous movement device 100 coincides with the hold location) (step S238). The autonomous movement device 100 returns from the hold state to the playback mode (step S240), and the process proceeds to step S204 in FIG. 11.

When the present direction of the autonomous movement device 100 is the opposite direction to the hold direction (step S237; Yes), the surrounding information converter 15 converts the surrounding environment recorded in the route storage 22 to data in the backward direction and the processor 10, by reversing the direction of the memorized data used in the playback from the start point to the hold point to the backward direction, sets a route in such a way that the autonomous movement device 100 returns to the start point (step S239). The autonomous movement device 100 returns from the hold state to the playback mode (step S240), and the process proceeds to step S204 in FIG. 11.

Note that it may be configured such that, in the determination in step S237, the process proceeds to step S238 in the case where a difference between the present direction and the hold direction is less than or equal to plus or minus 90 degrees and the process proceeds to step S239 in the other case, and, in step S239, processing in which the movement controller 16 controls the driven wheels 40 to cause the autonomous movement device 100 to turn in such a way that the direction of the autonomous movement device 100 coincides with the opposite direction to the hold direction (in addition, in such a way that the location coincides with the hold location) is performed.

The playback processing was described above. In the playback processing, the processor 10 controls the driven wheels 40, based on the memorized data to cause the autonomous movement device 100 to autonomously travel (step S213). At a hold point that is a point at which the travel of the autonomous movement device 100 is to be suspended (step S216; Yes), the processor 10 controls the driven wheels 40, based on a user operation acquired by the operation acquirer 32 to cause the autonomous movement device 100 to travel (manual travel) in a travel mode other than the autonomous travel (step S231). When the autonomous movement device reaches near the hold point in a travel mode other than the autonomous travel (step S234; Yes), the processor 10 causes the autonomous travel that has been suspended to be resumed (steps S240 to S213).

Therefore, at the hold point, the autonomous movement device 100 transitions from the playback mode to the hold state and the user can cause the autonomous movement device 100 to freely travel in an arbitrary travel mode (guided travel mode) other than the autonomous travel. For example, the autonomous movement device 100 can, after a worker operates the autonomous movement device 100 and puts the autonomous movement device 100 into the hold state at an arbitrary point during autonomous travel, leave the route for autonomous travel (teaching route), move near an object to be transported in the autonomous target following mode, and, after objects to be transported are loaded and unloaded, return to the hold point in the autonomous target following mode. Subsequently, the autonomous movement device 100 can be returned from the hold state to the playback mode at the hold point. Note that, although, in the above-described playback processing, regarding movement instructions in the hold state, instructions provided by the joystick 321 of the operation acquirer 32 were mainly described, movement instructions in the hold state are not limited to the instructions provided by the joystick 321. In a similar manner to the operation described in the memorizing processing in FIG. 9, it is possible to switch the travel mode among the manual operation mode, the autonomous target following mode, the line trace mode, and the like by pressing the start button 3226, and, even from the hold state, the user can cause the autonomous movement device 100 to travel in not only the manual operation mode but also an arbitrary travel mode other than the autonomous travel (the line trace, the manual operation travel, the autonomous target following travel, the hand-pushing travel, the remote operation travel, travel based on an instruction from another system, or the like).

In addition, the processor 10 memorizes the travel direction at the hold point as a hold direction (step S222) and, when the autonomous movement device reaches near the hold point (step S234; Yes), determines whether or not the present direction coincides with the hold direction (step S236), and, when the present direction does not coincide with the hold direction (step S236; No), controls the driven wheels 40 to cause the autonomous movement device 100 to turn in such a way that the present direction coincides with the hold direction (step S238) and subsequently causes the autonomous travel that has been suspended to be resumed (steps S240 to S213). Therefore, the user can return the autonomous movement device 100 from the hold state to the playback mode without caring the direction of the autonomous movement device 100 in the hold state.

In addition, the processor 10 memorizes the travel direction at the hold point as a hold direction (step S222) and, when the autonomous movement device reaches near the hold point (step S234; Yes), determines whether or not the present direction is the opposite direction to the hold direction (step S237), and, when the present direction is the opposite direction to the hold direction (step S237; Yes), sets the direction of the route along which the autonomous movement device 100 has autonomously traveled up to that time to the backward direction in such a way that the route returns to the start point (step S239) and subsequently causes the autonomous travel to be resumed (steps S240 to S213). Therefore, the user can easily return the autonomous movement device 100 to the start point of the teaching route by reversing the direction of the autonomous movement device 100 to the opposite direction and returning the autonomous movement device 100 to the hold point.

In addition, when the processor 10 acquires a user operation by the operation acquirer 32 during autonomous travel (step S217; Yes), the processor 10 suspends the autonomous travel (step S243) and records the location and direction of the autonomous movement device 100 at that moment in the storage 20 as a hold location and a hold direction, respectively (step S244). Through this processing, the user can set an arbitrary point as a hold point at the time of playback without teaching a hold location at the time of teaching in advance.

In addition, although, when the playback button 3222 is pressed while the travel mode is a guided travel mode (the manual operation mode, the autonomous target following mode, or the like), the autonomous movement device 100 is switched to the playback mode and the autonomous travel (travel by the playback processing) is performed (from step S201 and onward), when the playback button 3222 is pressed while the autonomous movement device 100 temporarily stops in the playback processing (step S223; Yes), the autonomous movement device 100 is switched to the hold state (step S226) and suspends the autonomous travel and the user can freely manually operate the autonomous movement device 100 or cause the autonomous movement device 100 to autonomously follow a following target (step S231). When the playback button 3222 is further pressed while the autonomous movement device 100 is in the hold state (step S232; Yes), the autonomous movement device 100 is switched to the playback mode (step S240) and the autonomous travel is resumed (from step S204 and onward). Since, as described above, even for the same operation (for example, pressing of the playback button 3222), different control (execution of the playback processing, switching to the hold state, and return to the playback mode) is performed depending on the state of the autonomous movement device 100, the user can operate the autonomous movement device 100 without getting lost in the operation method.

In addition, the processor 10 is capable of, when the autonomous movement device 100 is switched to the hold state, causing the output device 33 to output a signal, such as turning on the LED 331, (step S226) and thereby notifying the user that the autonomous travel can be resumed (the travel mode can be returned to the playback mode). Because of this configuration, the user can easily notice whether or not the playback processing can be resumed after the manual operation.

In addition, the processor 10 is capable of, by, at the time of the target following teaching, recognizing a following target (step S105) and, at the time of generating route data of the surrounding environment (step S112), removing point cloud data of the following target from the route data (step S113), generating the route data without using the point cloud data of the following target but using point cloud data of objects other than the following target. Although, since the following target does not exist at the time of the playback processing, the point cloud data of the following target become data considered as noise in the route data, performing processing as described above enables the data considered as noise to be removed and precision of self-location estimation or the like at the time of the playback processing to be improved.

In addition, when the storage of memorized data is finished, the processor 10 outputs a finish sound as a signal indicating that the memorizing processing is finished (step S118). Through this processing, the user can easily notice that memorized data are normally recorded.

In addition, at the time of causing the autonomous movement device 100 to autonomously travel based on memorized data by the playback processing, the processor 10 adjusts the travel path lest the autonomous movement device 100 collide with an obstacle existing in the travel direction (step S207). Because of this configuration, even in the case where the location of an obstacle has slightly moved from the location at the time of teaching or the case where, when the autonomous movement device 100 travels along the route at the time of teaching without change, there is a possibility that the autonomous movement device 100 collides with an obstacle due to influence of quantity of loads or the like, the wear state of tires, sensor error, error in motor control, or the like, the autonomous movement device 100 is capable of traveling by adjusting the route in such a way as to avoid the obstacle when the obstacle is avoidable. In addition, since, when an obstacle is unavoidable (when an obstacle cannot be avoided unless the autonomous movement device 100 avoids the obstacle to such an extent as to make it impossible to estimate the self-location, when an interspace between obstacles is too narrow to pass through, or the like), the autonomous movement device 100 temporarily stops (step S208), the user can put the autonomous movement device 100 into the hold state at the location of the temporary stop and cause the autonomous movement device 100 to freely travel in an arbitrary travel mode.

Note that, in the above-described embodiment, what type of device is to be used as the operation acquirer 32 (for example, the joystick 321, the push button 322, or the like), how the operation method is to be set (for example, when the playback button 3222 is pressed during the playback processing, the autonomous movement device 100 temporarily stops, or the like), and what is to be selected as a signal to be notified to the user (for example, turning on/off of the LED 331 or output of a sound) are only examples. For example, it may be configured to flash the LED 331 in place of or in addition to outputting an error sound in steps S203 and S235 in the playback processing, and an LED for notifying an error may be installed separately from the LED 331 and configured to be turned on.

An example of the playback processing is described below with reference to FIG. 10. First, it is assumed that teaching has been performed in advance by the above-described target following memorizing processing, in which the autonomous movement device 100 followed the user from the first point 81 to the second point 82, and the third point 83 located at an intermediate point on the teaching route is specified as a hold point. Then, as a result of the memorizing processing, point data (first point data) of the start point, point data (second point data) of the goal point, and point data (third point data) of the hold point are respectively memorized in the point storage 21, a surrounding environment at the time when the autonomous movement device 100 moved along the route (first teaching route) from the first point 81 to the second point 82 are memorized in the route storage 22, and memorized data that were taught by the route from the first point 81 to the second point 82 are memorized in the memorized data storage 23.

It is assumed that the autonomous movement device 100 receives an instruction to start playback from the user when the autonomous movement device 100 is located at the first point 81 while facing in the direction toward the second point 82. Then, the processor 10 acquires the present location of the autonomous movement device 100 (step S201). In this example, the processor 10 compares the surrounding environment 60a detected by the sensor 31 with the respective point data (a surrounding environment) that are recorded in the point storage 21.

Then, since the surrounding environment 60a coincide with the point data (first point data) of the start point recorded in the point storage 21, the processor 10 can determine that the present location is the first point 81. Therefore, the determination in step S202 results in Yes.

The processor 10 performs scanning using the sensor 31 (step S204). The determination in step S205 results in No because there exists no obstacle in the example in FIG. 10, and, while the processor 10, by comparing a surrounding environment detected by the sensor 31 with the surrounding environment recorded in the route storage 22 (for example, the surrounding environments 60b, 60c, 60d, and 60e), grasps the present location and direction of the autonomous movement device 100, the movement controller 16 controls the driven wheels 40 to cause the autonomous movement device 100 to travel in accordance with the memorized data (step S213).

When the autonomous movement device 100 arrives at the hold point (third point 83) (step S216; Yes), the autonomous movement device 100 temporarily stops (step S221). When, at this time, the user presses the playback button 3222 and thereby provides a hold instruction (step S223; Yes), the autonomous movement device 100 is brought into the hold state (step S226), and the user can cause the autonomous movement device 100 to freely move (in not only the manual operation mode but also an arbitrary travel mode including the autonomous target following mode, the hand-pushing travel, and the like) by the joystick 321 or the like (step S231).

When the user, after causing the autonomous movement device 100 to freely move in an arbitrary travel mode, such as the manual operation mode, the autonomous target following mode, and the hand-pushing travel, as illustrated by, for example, a route 68 in FIG. 10, presses the playback button 3222 again near the hold point (third point 83) (step S232; Yes), the autonomous movement device 100 turns and faces in the direction at the time when the autonomous movement device 100 was brought into the hold state, as needed basis (step S238) and returns from the hold state to the playback mode (step S240).

The autonomous movement device 100 resumes scanning (step S204) and travel (step S213) again, and, when the autonomous movement device 100 arrives at the goal point (second point 82) (step S214; Yes), the autonomous movement device 100 stops (step S215) and terminates the playback processing.

In this way, the processor 10 is capable of causing the autonomous movement device 100 to autonomously travel along a taught route and also causing the autonomous movement device 100 to temporarily travel in a guided travel mode (a travel mode other than the autonomous travel, such as the line trace, the manual operation travel, the autonomous target following travel, the hand-pushing travel, the remote operation travel, and travel based on an instruction from another system) at an intermediate point (hold point) on the route. In the prior art, when, during autonomous travel, an autonomous movement device is to perform an operation that needs to be performed at a point separated from a route for autonomous travel, the autonomous movement device has no other choice but to cancel the autonomous travel, and, in some cases, a process to restart the autonomous travel is complicated or it is impossible to restart the autonomous travel. Since, according to the present disclosure, in collaborative transportation operation between a person and the autonomous movement device 100, the autonomous movement device 100 is capable of temporarily changing the travel mode flexibly even during autonomous travel, the present disclosure enables flexible operation. In addition, since the autonomous movement device 100 is capable of temporarily stopping at an arbitrary point even during autonomous travel, switching the travel mode to the hold state, and performing an arbitrary operation and, after performing the operation, easily performing return from the hold state to the original autonomous travel, the present disclosure enables smooth collaborative transportation operation.

Note that, when the autonomous movement device 100 receives an instruction to start playback from the user when the autonomous movement device 100 is located at the first point 81 while facing in a direction opposite to the direction toward the second point 82, the processor 10 grasps that the present location of the autonomous movement device 100 is the first point 81 and the autonomous movement device 100 faces in the direction opposite to the direction toward the second point 82 by comparing the surrounding environment 60 g detected by the sensor 31 with the first point data (a surrounding environment 60a) recorded in the point storage 21. In this case, the movement controller 16 is to, after controlling the driven wheels 40 to cause the autonomous movement device 100 to turn in such a way as to change the direction of the autonomous movement device 100 to the opposite direction, cause the autonomous movement device 100 to travel to the second point 82 in the manner described above.

In addition, it is assumed that, subsequently, teaching of a second teaching route in which the autonomous movement device 100 travels from the third point 83 to the fourth point 84 is performed through the above-described target following memorizing processing. Then, as a result of the memorizing processing, point data (third point data) of the start point and point data (fourth point data) of the goal point of the second teaching route are also recorded in the point storage 21. In addition, a surrounding environment at the time when the autonomous movement device 100 moved along the route (second teaching route) from the third point 83 to the fourth point 84 are recorded in the route storage 22, and memorized data that were taught by the route from the third point 83 to the fourth point 84 are recorded in the memorized data storage 23.

It is assumed that the autonomous movement device 100 receives an instruction to start reverse playback from the user when the autonomous movement device 100 is located at the fourth point 84 while facing in the direction toward the third point 83. Then, the processor 10 compares a surrounding environment 60k detected by the sensor 31 with the respective point data (for example, the surrounding environment 60j of the fourth point 84) that are recorded in the point storage 21.

Then, since, as described above, the surrounding environment 60k and the surrounding environment 60j match with each other in an angular range of 140 degrees on each of the right and left sides, the processor 10 can determine that the present location is the fourth point 84. Therefore, the determination in step S202 results in Yes. The surrounding information converter 15 converts, among the route data memorized in the route storage 22, the surrounding environments 60h and 60i, which were detected by the sensor 31 at the time of the memorizing processing, to data in the case where the surrounding environments are detected in the backward direction and thereby generates backward direction data (backward direction data 60h′ and 60i′), and records the backward direction data in the route storage 22.

The processor 10, by reproducing the memorized data of the second teaching route in the backward direction while grasping the present location and direction of the autonomous movement device 100, causes the autonomous movement device 100 to travel from the fourth point 84 to the third point 83. In this way, the autonomous movement device 100 is capable of causing the taught route to be reproduced in the backward direction.

In addition, as described above, the processor 10 is capable of storing a temporary stop position P1 and a temporary stop time T1 in step S115 in the memorizing processing. Because of this configuration, the processor 10 is capable of controlling the autonomous movement device 100 to stop at the temporary stop position P1 for the temporary stop time T1 at the time of the playback processing (at the time when the autonomous movement device 100 autonomously travels in accordance with the recorded memorized data). For example, when an automatic shutter exists on a travel path that the autonomous movement device 100 memorized, by storing the location of the automatic shutter and causing the autonomous movement device 100 to temporarily stop in front of the automatic shutter until the shutter door is fully opened, it is possible to cause the autonomous movement device 100 to move more flexibly.

Although storage of the temporary stop position P1 and the temporary stop time T1 can be performed while the memorizing processing is performed, it may be configured such that the storage of the temporary stop position P1 and the temporary stop time T1 can be performed in the form of editing memorized data after the memorizing processing is finished. It may also be configured such that the memorized data is, for example, sent to a PC or a smartphone and the editing can be performed on the screen of the PC or the smartphone.

In addition, the processor 10 may, for example, memorize not only turning on/off of the LED 331 or the like but also an output position P2 at which a control signal S to a predetermined device is output (and a temporary stop time T2, when necessary), and, at the time of the playback processing (when the autonomous movement device 100 travels in accordance with the recorded memorized data), perform control in such a way as to output the control signal S at the output position P2 at which a signal to the predetermined device is output and thereby cause the predetermined device to operate (or prevent the predetermined device from operating).

For example, it is assumed that, when the processor 10 is capable of storing 4-bits output patterns “0000” to “1111”, an output pattern (for example, “0001”) of a control signal S1 for disconnecting a connection mechanism by which a towable pallet dolly or the like is connected to the autonomous movement device 100 and an output pattern (for example, “0000”) of a control signal S2 for not disconnecting the connection mechanism are defined. Then, it is possible to memorize a setting for, by outputting the control signal S1 having the output pattern “0001” at the predetermined output position P2, disconnecting the connection mechanism by which the towable pallet dolly or the like is connected to the autonomous movement device 100 (and, further, temporarily stopping for the time T2 required for the disconnection), a setting for, by outputting the control signal S2 having the output pattern “0000”, not disconnecting the connection mechanism by which the towable pallet dolly or the like is connected to the autonomous movement device 100, or the like.

Because of this configuration, it becomes possible to cause the autonomous movement device 100 to move more flexibly by selecting whether or not the autonomous movement device 100 disconnects the connection mechanism by which the towable pallet dolly or the like is connected to the autonomous movement device 100 and leaves the loads at a predetermined position on a travel path that the autonomous movement device 100 memorized, or the like. It may be configured such that storage of the control signal S, the output position P2 at which a control signal is output and the temporary stop time T2 can be performed while the memorizing processing is performed or can be performed in the form of editing memorized data after the memorizing processing is finished.

In addition, the autonomous movement device 100 may be configured to be capable of controlling an ultraviolet radiation lamp as the predetermined device. Then, the above-described “output of a control signal to a predetermined device” can be used for on/off control of the ultraviolet radiation lamp. For example, it is possible to, by outputting the control signal S at the output position P2, perform control in such a manner as to cause the ultraviolet radiation lamp to operate (or stop operating).

In addition, the autonomous movement device 100 may be configured to be capable of storing, in place of the output position P2, a condition C for outputting the control signal S. That is, the processor 10 may memorize the condition C for outputting the control signal S to a predetermined device in step S115 in the above-described memorizing processing, and, at the time of the playback processing (when the autonomous movement device 100 travels in accordance with the recorded memorized data), perform control in such a way as to output the control signal S to the predetermined device when the condition C is satisfied and thereby cause the predetermined device to operate (or prevent the predetermined device from operating).

For example, by causing a condition C requiring that “the sensor 31 detects that a person has come close to the autonomous movement device 100” to be memorized, the processor 10 can perform control in such a way as to stop radiation of ultraviolet rays when the sensor 31 detects that a person is coming close to the autonomous movement device 100. In addition, the predetermined device may be configured to be changeable between at the time of teaching and at the time of playback. For example, when, while it is desirable to radiate ultraviolet rays at the time of playback, it is desirable not to radiate ultraviolet rays at the time of teaching (however, it is desirable to confirm how the ultraviolet radiation is performed, using a pilot lamp or the like), the predetermined device may be able to be set in such a way that “a pilot lamp is turned on at the time of teaching and an ultraviolet radiation lamp is turned on at the time of playback”.

This setting enables the autonomous movement device 100 to be configured to stop the ultraviolet radiation and allow an output signal to be confirmed by another pilot lamp or the like during teaching and to radiate ultraviolet rays during playback. This configuration enables ultraviolet rays to be radiated to only a specific site and radiation of ultraviolet rays to be stopped during teaching in which a person is present near the autonomous movement device 100.

Further, the autonomous movement device 100 may be configured to be capable of selecting a velocity mode. Conceivable examples of the velocity mode include a teaching velocity mode (a mode in which an actual velocity at the time when the target following teaching or the manual teaching is performed is memorized and, at the time of playback, the autonomous movement device 100 travels at the same velocity as the velocity at the time of teaching) and a set velocity mode (a mode in which the user can memorize an arbitrary control velocity as a velocity at the time of playback and, at the time of playback, the autonomous movement device 100 travels at the memorized control velocity). The processor 10 can select a velocity mode in the above-described memorizing processing and memorizes the selected velocity mode in conjunction with the route data.

When the set velocity mode is selected as a velocity mode, the processor 10 may memorize a control velocity that the user sets (by, for example, the speed decrease button 3224 or the speed increase button 3225) in step S115 in the above-described memorizing processing, and, at the time of the playback processing (when the autonomous movement device 100 travels in accordance with the recorded memorized data), control the autonomous movement device 100 to travel at the memorized control velocity. Alternatively, when the teaching velocity mode is selected as a velocity mode, the processor 10 may memorize an actual velocity at the time of teaching travel in the above-described memorizing processing, and, at the time of the playback processing (when the autonomous movement device 100 travels in accordance with the recorded memorized data), control the autonomous movement device 100 to travel at the same velocity as the velocity at the time of teaching.

As described above, the processor 10 may memorize a velocity mode that the user selects or a control velocity that the user sets in the above-described memorizing processing, and, at the time of the playback processing (when the autonomous movement device 100 travels in accordance with the memorized memorized data), control the driven wheels 40 to control travel velocity, based on the memorized velocity mode or control velocity. Because of this configuration, it becomes possible to cause the autonomous movement device 100 to move at a desirable velocity at the time of playback. It may be configured such that storage of a control velocity or a velocity mode can be performed while the memorizing processing is performed or can be performed in the form of editing memorized data after the memorizing processing is finished.

It may also be configured such that, as the control velocity, velocity at an arbitrary position on a travel path can be memorized. For example, as control velocity at the time of traveling straight, a comparatively high velocity may be memorized, and, as control velocity at the time of turning, a comparatively low velocity may be memorized. In addition, it may be configured such that a plurality of control velocities can be memorized in such a way that a different control velocity can be set depending on a condition. For example, it may be configured to memorize a comparatively low velocity as control velocity in the case where a load is heavier than a standard weight (for example, 10 kg) and memorize a comparatively high velocity as control velocity in the case where a load is less than or equal to the standard weight.

Note that causing various data as described above (the temporary stop position P1, the time T1, the control signal S, the output position P2, the condition C, the velocity mode, the control velocity, and the like) to be additionally memorized in memorized data can be performed in, for example, step S115 in the memorizing processing. Therefore, it is possible to memorize the above-described memorized data in the memorized data storage 23 in the case of not only the target following teaching in which teaching is performed by causing the autonomous movement device 100 to recognize and follow a following target but also the manual teaching in which teaching is performed using the operation acquirer 32, such as the joystick 321.

### Variations

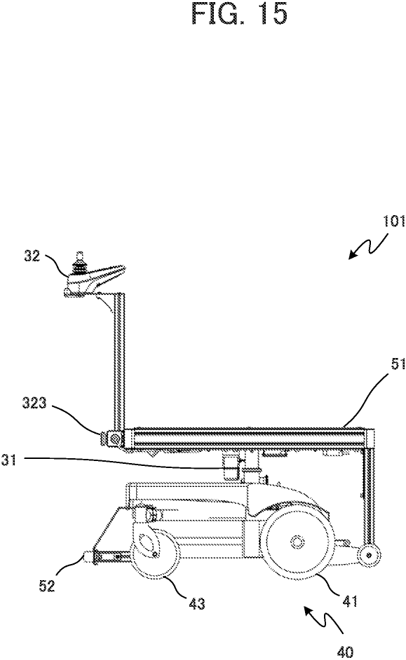

Although, in the autonomous movement device 100, the sensor 31 is disposed above the operation acquirer 32, as illustrated in FIG. 2, the installation position of the sensor 31 is not limited to this position. For example, as illustrated in FIG. 15, an autonomous movement device 101 according to a variation of Embodiment 1 includes a sensor 31 below a loading platform 51. Although, as described above, the autonomous movement device 100 is capable of detecting an obstacle, using only the sensor 31, since the autonomous movement device 101 according to the variation is capable of detecting an obstacle from a lower position, it becomes possible to avoid even a comparatively small obstacle.

Note that, regarding an obstacle, a dedicated sensor to detect an obstacle may be installed separately from the sensor 31. As for the dedicated sensor to detect an obstacle, installing, for example, a bumper sensor in the bumper 52 is conceivable. In this case, when the processor 10, using the bumper sensor, detects that the autonomous movement device 100 or 101 has come into contact with an obstacle, the processor 10 is capable of performing processing like causing the autonomous movement device 100 or 101 to stop, to slightly move backward, and the like.

In the present disclosure, an advantageous effect can be expected in which a setup cost and flexibility of an autonomous movement device can be substantially improved. A conventional technology, such as an autonomous movement device or an automated guided vehicle using the afore-described SLAM, generally requires a specialized engineer for setting up operation, and the setup has been considered to require several hours even in the case where a route along which an autonomous movement device or an automated guided vehicle is caused to autonomously travel is a simple route and to require several days for a large-scale route. In such conventional technologies, confirmation work of consistency of a map and correction work in the case where cumulative error is large require specialized knowledge, and it is required to perform extensive setup again every time the environment changes even for a slight change in the position of a load, and such a situation has generated a cost.

In addition, in the above-described embodiment, the processor 10 saves a map on a frame-by-frame basis and performs location estimation and travel control within each frame. Since, for this reason, cumulative error is generated only within a frame and, when the target frame changes to another frame, the location estimation and route travel are performed within the new map frame, a so-called closed-loop problem does not occur in principle. Although, in this method, there is a problem in that global self-location estimation becomes difficult, in the operation of this method at many customer sites, the global self-location estimation is basically unnecessary because a simple round-trip autonomous travel between two points is mainly used. Since, in the operation at many customer sites, the environment and operation, such as locations and loading order of loads, frequently change, there is a high demand for a capability of performing a setup operation in a simple manner. In the present disclosure, an operator (user) can set up operation of an autonomous movement device even without specialized knowledge by performing target following teaching while walking once along a route along which the operator desires to carry out automated transportation. In addition, it is possible to, by causing the autonomous movement device to temporarily stop at an arbitrary point during autonomous travel and switching the state of the autonomous movement device to the hold state, cause the autonomous movement device to perform other work and subsequently return to the autonomous travel, which enables simple and flexible automated transportation to be constructed.

Note that the respective functions of the autonomous movement device 100 or 101 can also be implemented by a general computer, such as a PC. Specifically, in the above-described embodiment, the description was made assuming that programs of the target following memorizing processing, the playback processing, and the like that the autonomous movement device 100 or 101 performs are memorized in advance in the ROM in the storage 20. However, a computer capable of achieving the above-described functions may be configured by storing programs in a non-transitory computer-readable recording medium, such as a flexible disk, a compact disc read only memory (CD-ROM), a digital versatile disc (DVD), a magneto-optical disc (MO), a memory card, and a universal serial bus (USB) memory, and distributing the recording medium and reading and installing the programs in the computer. A computer capable of achieving the above-described functions may also be configured by distributing programs via a communication network, such as the Internet, and reading and installing the programs in the computer.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of International Patent Application No. PCT/JP2020/23468, filed on Jun. 15, 2020, the entire disclosure of which is incorporated by reference herein.

Reference Signs List

| | |
|---|---|
| 10 | Processor |
| 11 | Surrounding information acquirer |
| 12 | Route generator |
| 13 | Self-location estimator |
| 14 | Memorized data recorder |
| 15 | Surrounding information converter |
| 16 | Movement controller |
| 20 | Storage |
| 21 | Point storage |
| 22 | Route storage |
| 23 | Memorized data storage |
| 31 | Sensor |
| 32 | Operation acquirer |
| 33 | Output device |
| 40 | Driven wheels |
| 41 | Wheel |
| 42 | Motor |
| 43 | Caster |
| 51 | Loading platform |
| 52 | Bumper |
| 60 | Dotted line |
| 60a, 60b, 60c, 60d, 60e, 60f, 60h, 60i, 60j, 60k, 60m, 60n | Surrounding environment |
| 60a′, 60b′, 60c′, 60d′, 60h′, 60i′ | Backward direction data |
| 60 ef | Shaded portion |
| 61 | Person |
| 63, 64 | Retro reflective material |
| 65, 75 | Point sequence |
| 66, 67 | User |
| 68, 76 | Route |
| 71 | Wall |
| 72, 73, 74 | Obstacle |
| 81, 82, 83, 84 | Point |
| 100, 101 | Autonomous movement device |
| 311 | Optical window |
| 312 | Laser |
| 313 | Rotational axis |
| 321 | Joystick |
| 323 | Push button |
| 331 | Emergency stop button |
| 322 | LED |
| 3221 | Storage button |
| 3222 | Playback button |
| 3223 | Loop playback button |
| 3224 | Speed decrease button |
| 3225 | Speed increase button |
| 3226 | Start button |

1. An autonomous movement device comprising:
driven wheels;
a storage; and
a processor,
wherein the processor
causes taught memorized data to be memorized in the storage,
based on the memorized data, controls the driven wheels to cause the autonomous movement device to autonomously travel,
at a hold point, the hold point being a point at which autonomous travel of the autonomous movement device is suspended, controls the driven wheels to cause the autonomous movement device to travel in a travel mode other than the autonomous travel, and
when the autonomous movement device reaches near the hold point in a travel mode other than the autonomous travel, causes the suspended autonomous travel to be resumed.

2. The autonomous movement device according to claim 1, wherein the processor,
at the hold point at which autonomous travel of the autonomous movement device is suspended, memorizes a travel direction of the autonomous movement device in the storage as a hold direction,
when the autonomous movement device reaches near the hold point in a travel mode other than the autonomous travel, determines whether or not a travel direction of the autonomous movement device coincides with the hold direction, and
when the travel direction does not coincide with the hold direction, after controlling the driven wheels to cause the autonomous movement device to turn in such a way that the travel direction coincides with the hold direction, causes the suspended autonomous travel to be resumed.

3. The autonomous movement device according to claim 1, wherein the processor,
at the hold point at which autonomous travel of the autonomous movement device is suspended, memorized a travel direction of the autonomous movement device in the storage as a hold direction,
when the autonomous movement device reaches near the hold point in a travel mode other than the autonomous travel, determines whether or not a travel direction of the autonomous movement device is an opposite direction to the hold direction, and
when the travel direction is an opposite direction to the hold direction, causes the autonomous travel to be resumed in such a way that the autonomous movement device travels to a start point at which the autonomous movement device started the autonomous travel, along a route obtained by reversing a direction of a route from the start point to the hold point.

4. The autonomous movement device according to claim 1 further comprising operation acquirer to acquire a user operation,
wherein, when the processor acquires a user operation by the operation acquirer during the autonomous travel, the processor suspends autonomous travel and memorizes a location of the autonomous movement device and a travel direction of the autonomous movement device at a moment of the suspension as a hold point and a hold direction, respectively, in the storage.

5. The autonomous movement device according to claim 1 further comprising operation acquirer to acquire a user operation,
wherein, even when the processor acquires a same operation by the operation acquirer, the processor performs different control depending on a state of the autonomous movement device at a moment of the acquisition on the autonomous movement device.

6. The autonomous movement device according to claim 1 further comprising an output device,
wherein, while the processor suspends the autonomous travel, the processor causes the output device to output a signal indicating that autonomous travel is resumable.

7. The autonomous movement device according to claim 1 further comprising a sensor to detect a surrounding object,
wherein the processor
recognizes a following target from among objects detected by the sensor, and
at a time of generating route data of a surrounding environment based on data of a point cloud detected by the sensor, generates the route data without using the data of the following target but using the data of an object other than the following target.

8. The autonomous movement device according to claim 1 further comprising an output device means,
wherein, when storage of the memorized data is finished, the processor causes the output device to output a signal indicating that memorizing processing is finished.

9. The autonomous movement device according to claim 1, wherein the processor, at a time of causing the autonomous movement device to autonomously travel based on the memorized data, adjusts a travel path.

10. An autonomous movement method for an autonomous movement device comprising:
memorizing taught memorized data in a storage;
based on the memorized data, controlling driven wheels to cause the autonomous movement device to autonomously travel;
at a hold point, the hold point being a point at which autonomous travel of the autonomous movement device is suspended, controlling the driven wheels to cause the autonomous movement device to travel in a travel mode other than the autonomous travel; and
when the autonomous movement device reaches near the hold point in a travel mode other than the autonomous travel, causing the suspended autonomous travel to be resumed.

11. (canceled)
